(19) United States
(12) Patent Application Publication
(10) Pub. No.: US 2021/0166171 A1
(43) Pub. Date: Jun. 3, 2021

(54) COMPUTER SYSTEM ARRANGEMENT AND METHODS FOR REDUCING COMMUNICATION AND INTEGRATION COMPLEXITY FOR FUNCTIONS SPANNING ACROSS SYSTEMS

(71) Applicant: Tarifflex AB, Stockholm (SE)

(72) Inventors: Johan JOBÉR, Tyresö (SE); Thomas NORBERG, Enskededalen (SE)

(73) Assignee: Tarifflex AB, Stockholm (SE)

(21) Appl. No.: 17/267,063

(22) PCT Filed: Aug. 16, 2019
(86) PCT No.: PCT/EP2019/072008

§ 371 Date: Feb. 9, 2021

(30) Foreign Application Priority Data
Aug. 31, 2018 (SE) 1851037-0

(51) Int. Cl. G06Q 10/06; G06F 9/54; G06N 5/02; H04L 29/06

(52) U.S. Cl. CPC G06Q 10/0637; G06Q 10/067; H04L 69/08; G06N 5/025; G06F 9/541

(57) ABSTRACT

A method and a computer system arrangement for minimizing communication and integration complexity between a plurality of external systems and/or software applications having each an individual data model defining an individual set of application parameters is disclosed. Specifically, the method and the computer system, or abstraction layer, have connections to each one of the plurality of external systems and/or software applications, where the computer system includes a plurality of adapters arranged to interpret between an external system and/or software application and to orchestrate incoming and outgoing requests from an external system and/or software application.

### TECHNICAL FIELD

The technology disclosed relates to methods and a computer system arrangement for reducing communication and integration complexity between a plurality of external systems and/or software applications having each an individual data model defining an individual set of application parameters. In addition to integrating the different systems, the computer system arrangement and technology disclosed also relates to methods and a computer system arrangement for reducing the complexity when building new functions and functionality into a plurality of external systems and/or software applications. Specifically, the technology disclosed relates to methods and a computer system arrangement, e.g. an abstraction layer or bus arrangement, having connections to each one of plurality of external systems and/or software applications, where the computer system arrangement is comprising a plurality of adapters arranged to interpret between each system/software application and the computer system/abstraction layer and to orchestrate incoming and outgoing requests from each external system/software application.

### BACKGROUND

Organizations typically automate their business processes to manage their operations. A business process includes a series of activities that may be undertaken to perform the operations of an organization. As an example, a business process may describe activities for processing a sales order, such as the steps of receiving a sales order, checking payment history, checking inventory, and so on. In this disclosure and the technology disclosed, a business process is a program implemented in hardware and/or software which is executed on a computer with the purpose of automatically handling business and/or operational tasks.

As an example, operators of telecommunication networks, utilities, and other types of services interact with their customers through telephone, web, letters, etc. The customers pay for the services based on their usage, tariff, agreement type, etc. In this disclosure, the technology is frequently described in the context of a telecommunications operator. However, it should be applicable also to other applications and industries with similar need for interactions between different support systems. The technology disclosed may also be particularly useful in combining IT systems from different industries.

Essentially all service providers, e.g. telecommunication operators, use IT systems to support their key processes. There is a large number of systems for billing, service activation such as provisioning, customer interaction, technical support, etc. that operators use to handle these functions with a minimum of manual interaction.

Examples of applications and industries other than in the context of a telecommunications operator where the technology disclosed may be implemented include, but are not limited to, bank and finance, public transport, healthcare, manufacturing and retail, logistics and resource management, smart energy, smart homes, smart cities and smart vehicles.

The IT systems where the technology disclosed may be implemented may be operated by the owner of the IT system in-house, e.g. a telecommunications operator, or outsourced to a third party.

### PROBLEMS WITH THE PRIOR ART

An organization may automate a business process by having a computer perform some activities such as receiving a sales order. Automating business processes, however, has posed challenges. Designing and executing automated business processes may involve the use of multiple programming languages to integrate with backend applications. It may also involve the use of diverse client-side devices and related applications to interface with people involved in a business process. The diversity of languages, devices, applications, people skills, geographies, and cultures may pose a challenge to automating a homogeneous business process that delivers a quality product and/or service to a diverse set of customers. The diversity of languages, devices, applications, people skills, geographies, and cultures has also led to an increasingly complexity when building new functions and functionality into existing systems.

As an example, customers may expect many ways to interact with an operator, e.g. phone, fax, email, mail, web self-service, IVR, etc. At the same time, the technical development and competitive pressure on the operators have made them produce many kinds of structures, e.g. tariff structures, for a variety of products and product bundles. This has led to increasing complexity for an operator to administrate the subscriptions, interaction with customers, accounting, activation/deactivation of services, troubleshooting, etc.

It is difficult to use a single all-in-one “standard” system to handle all of these interactions because all operators are different in that they often have different network equipment, different legislation, languages, and local practices. Therefore, the support systems are often configured to handle a certain task like billing, customer care, provisioning, accounting, etc., where the task needs to be adapted to the business environment of different operators. The diversity of network equipment, different legislation, languages, and local practices has also led to an increasingly complexity when building new functions and functionality into existing systems.

Manual interaction needs to be minimized due to the large volume of transactions that need to be processed. Even more importantly, manual handling is very difficult due to the large number of pricing and product packaging combinations that are common.

Many operators prefer to outsource certain activities, e.g. billing, customer service, etc., making it even more likely that different systems, each having its own information models, are used by each outsourcing partner. This has led to an ever-increasing complexity and cost for operators to keep all support systems synchronized. This is because different service partners or systems are needed to perform each task efficiently, but at the same time the systems need to interact with each other to update data, to retrieve information, and perform various functions.

As e.g. the operator's networks are made more complex to support more functions, additional support systems are required that need to interact with many other systems.

The result is that the operators are struggling with integrating the different business support system functions with each other, often with one system depending on many others. It also often depends on data and configurations being made in different systems rather than in a single location.

FIG. 1 illustrates a known computer arrangement system in which the problem is that many systems are integrated and which gives an example where product prices are entered into several systems which is quite common in these kinds of architectures.

Each integration takes time and costs money to implement, test, maintain and update. Therefore, the costs and time of the integration, as well as possible sources of error increase rapidly with the number of systems.

In summary, the architecture of the system in FIG. 1 has the following disadvantages:
Large amount of integration and configuration to get the system operational.
Due to the many interactions with many other systems, it is very difficult to replace one system if its supplier stops supporting it or it becomes unreliable or insufficient for some other reason.
Difficult, slow, and costly to make any changes in the customer offering.
The complexity increases rapidly with the number of systems (102), making it difficult to scale to large number of systems or to accommodate several operators needs in one system.
Each system that integrates with another system needs to know the communication ability as well as the information definition and structure of that system.
Data and rules are duplicated.

Several known methods to mitigate some of the problems outlined above have been considered and to various degrees implemented, including:
1. Standards exist for how to describe information when exchanging information between support systems. It is known that adherence to a common information model can simplify exchange of data between subsystems. It is typically referred to as a shared, common, or canonical data model.
2. Various concepts for Information Bus/Enterprise Application Integration/Integration bus/Integration hub/Information Hub (many names for the same or similar concepts exist). These function by acting as a connecting hub and thus facilitating interconnection and exchange of information between different support systems.

An example is described in FIG. 2 (WO 02/065360). In this example, an Enterprise Application Integration bus serves the function to interconnect the different subsystems, including making a data mapping from the data formats in one system to that in the other.

The methods listed above have some merit, but have the following shortcomings:
The standardized/shared/canonical information model only works well when all subsystems adhere to them. In reality, this is rarely the case. It is also a problem when it is extended and e.g. new information is added since these additions cannot be made in all systems simultaneously. It could also be that new features, requiring exchange of data not yet in the standard information model, requires proprietary modifications. This means that to stay in the frontline of functional development, it is difficult to follow a standard and the implementation is in fact bound to diverge from the standard information model. Such divergence from the standard is difficult to maintain in all affected subsystems simultaneously.
The Information bus concept as typically implemented and as described in the example, only concentrates the problem of integration to the data mapping in the bus. The basic problem with many-many relationship remains, just that each translation (or at least a part of it) takes place in the data mapping in the bus. Therefore, the basic problem that each system is dependent on integration with many others is not mitigated.

Even if integrated, the different subsystems often use different names and concepts making it hard to follow and relate to the meaning of, say, an “account” when staff are working with the different systems and talk to each other. An “account” in one system made to serve the billing department/function may roughly be referred to as a “customer” in another system made to serve the customer support department/function, while the concept in the sales department might be “subscription”. Furthermore, there may not be a 1:1 mapping between these. One customer may have several accounts, each with several subscriptions which in turn uses several “terminals” activated with different “functions”. Even if vaguely related, it is hard to intuitively understand how the concepts relate to each other since the translations and mapping is made between each pair of subsystems.

Effective management of electronic business processes requires a comprehensive on-line platform capable of real-time dynamic control and reporting of system status. Prior art systems and methodologies, however, lack the ability to provide automated self-management based upon a real-time coordination of business rules, business metrics, and system resources.

For example, prior art electronic business process management systems tend to implement business process flow control based on a rigid array of static rules. Although some prior art systems provide a user-interface for manually defining or editing rule parameters, no system or methodology exists for managing electronic business processes with rules that are dynamically triggered and adapted in an automated fashion based on the critical value of business-critical metrics such as business transaction volume, response time, turn-around time, event priority, etc.

Conventionally, existing systems tend to generate system status reports and await user analysis and response before reacting to changing environmental conditions such as resource usage or client demand. What is needed is a method and system possessing functionality to automatically administer necessary business process (i.e. business process timing and attributes) during real-time system operation based on dynamically-generated event objects and system metrics.

Another disadvantage of prior art electronic business control systems is their inability to adjust business rules “on-the-fly” without interfering with business process flow. Such functionality, however, is critical in an on-line environment where clients continuously request system response and process performance.

Yet another drawback to prior art electronic business management systems is their failure to define business rule parameters and business metrics in a standard format such that they may be interchangeably used by rules for decisions, as well as updated by rules in response to internal or external events. Additionally, business metrics defined by prior art systems lack the ability to independently generate event objects for triggering subsequent system control.

Other disadvantages of prior art systems include their inability to execute business rules in response to events generated externally or in response to a correlation of event objects generated over time.

What is needed is a method and system for dynamically managing business processes that solves these and other problems associated with prior art electronic business management systems and methodologies.

From US2007/0208768 there is known a system for modeling of activity data. In this known system the process is based on subordinating information in relation to activities. The data model uses a plurality of activity classes, wherein each activity class includes a set of data elements that is common to various activity types. The activity class defines relationships of an activity with various entities related to the activity. For each activity class there is a separate data model for mapping of information. A plurality of different mapping models must be handled and structured by means of the system, which leads to an undesired complexity. Furthermore, the preferred embodiment described in the application implies a kind of point to point interaction by means of the central data handling device, being in the form of a server rather than a bus.

US 2003/120502 and US 2008/049920 include various use of an integration bus. These systems differ from the technology disclosed in that they do not use the concept of a data model that is independent of each data model in the subsystems. Rather these documents refer to a shared or canonical data model. They therefore do not include the concept of double translations to and from an intermediary and independent data model. The solutions disclosed in these documents lack a simple way to make the mapping to the information model used in the organization and they are silent to a process including the implementation of a plurality of adapters in a bus arrangement which also are configured to invoke a business process implemented in hardware and/or software with the purpose of interconnecting each connection to a software application with a generic information model defining a set of generic parameters in relation to the application parameters of each of a plurality of software applications. Hence, the solutions mentioned in these documents do not describe any way how to practically implement a solution which can obtain the advantages provided by the technology disclosed and they therefore suffer from massive practical problems.

### SUMMARY

The technology disclosed relates to an abstraction layer, a computer system arrangement, or bus arrangement, according to the pre-characterizing portions of any of the independent system claims and methods to execute the same according to the preamble of independent method claims.

One object of the technology disclosed is to provide a computer system arrangement, e.g. an abstraction layer or bus arrangement such as an information bus or integration bus, which is more effective and sets aside or at least minimizes, the disadvantages mentioned above concerning known systems. Another object of the technology disclosed is to provide methods to execute the functions of computer system arrangement. In addition to integrating the different systems that an entity needs, the computer system arrangement and technology disclosed is also configured to decrease the complexity when introducing new functions and functionality that span across several applications with a minimum of cost and effort. With the technology disclosed, a new function may in many cases be built without any changes in each utilized application. If some cases when a new function is introduced using the computer system arrangement and technology disclosed, an additional system is needed to realize some parts of the desired function, e.g. a new adapter may be introduced made for the new function and/or system. In these cases when using the technology disclosed, there are often no need for any significant changes to any of the pre-existing applications. The computer system arrangement and technology disclosed may be in particular beneficial when introducing e.g. Artificial Intelligence (AI) in the business of an enterprise where the AI function spans across systems that may each be very simple or advanced. By using the solutions of the technology disclosed, it would for example be possible to make a smart Enterprise built on simple applications, e.g. the operator of a machine can undertake amazing tasks even if the machine/tools are very simple. The technology disclosed provides for efficient methods to gradually implement new functions and functionalities, even AI, in entities even if the entities themselves are very simple, have connections to many other entities and/or are connected to very old/legacy systems.

These objects are achieved by means of a computer system arrangement, abstraction layer or information bus, as defined by the independent system claims and a method as defined by the independent method claims, which provides significant advantages.

The dependent claims and the disclosed “list of itemized embodiments” define different embodiments of the technology disclosed.

A computer system arrangement, an abstraction layer or information bus according to the technology disclosed introduces a method to integrate subsystems in an efficient way, handling product definitions and prices. Each IT system, either local, cloud based or external, i.e. which needs to be integrated with others, has a data specific data model, not looking or defined like any other system. Each concept and IT system specific data model is transformed into a generic information model with its generic concepts which the abstraction layer can act upon. This is done in the adapters. The technology disclosed further relates to the information model used in the IT systems and in the abstraction layer, or computer system, to concepts used in the organization in an intuitive way. All this may be performed without placing significant new requirements on already existing subsystems, which makes the computer system arrangement according to the technology disclosed useful as an improvement of both existing and new business support system installations for integrating different subsystems in the organization or on the market.

To construct the system described in this disclosure, one would make the necessary data mapping/conversion/translation/formatting/protocol adaptations between each subsystem and the abstraction layer, or bus arrangement. A description is also made to get an overview of the relation between the model used by the organization (organizational information model) and the information model in the abstraction layer (generic information model).

These mapping/integration activities between the subsystems data models and the information model in the abstraction layer and between the information model in the organization and the data models for each subsystem are central parts of the solution according to the technology disclosed. To make sure it is documented and maintained in a good way in larger systems, it is recommended to use a tool for structured graphical programming both for the initial design and to make changes through the tool.

Additional programming and hardware may be required depending on the nature of each subsystem to ensure a well-functioning integration, for instance to match physical and logical interfaces, security and safety, physical location, etc.

The technology disclosed relates to methods and a computer system, e.g. an abstraction layer, an information or integration bus, for minimizing communication and integration complexity between a plurality of software applications having each an individual data model defining an individual set of application parameters. In embodiments, the technology disclosed relates to a method and a computer system, or abstraction layer, having connections to each one of at least two software applications, where the bus is arranged to interpret between each application and to orchestrate incoming and outgoing requests from each of the at least two software applications.

In embodiments, the technology disclosed relates to a method and a computer system arrangement 20, e.g. an abstraction layer, information bus, or integration bus, having connections to each one of at least three external systems and/or software applications 3a-o, where the computer system arrangement 20 is arranged to interpret between each application and to orchestrate incoming and outgoing requests from each of at least three external systems and/or software applications 3a-o. In this embodiment, the computer system arrangement comprises at least three adapters 23a-o, where each of the at least three adapters is arranged for both performing mapping between at least one parameter of an individual data model and at least one generic parameter of the information bus, and for invoking at least one business process based on at least one of a single request received from a software application and a single request from within the bus arrangement, and where the execution of the at least one business process involves interaction with at least two other adapters of the bus arrangement.

In embodiments, technology disclosed relates to a computer system arrangement such as an abstraction layer, information bus, or integration bus, for minimizing communication and integration complexity between at least three external systems and/or software applications, wherein each of the at least three software applications 3a-o has an individual data model 7a-o each defining an individual set of application parameters 70a-o. The computer system arrangement 20 is having connections 24a-o to each one of the at least three software applications 3a-o. The computer system 20 is arranged for interpreting between each of the at least three external systems and/or software applications 3a-o and to orchestrate incoming and outgoing requests from each of the at least three external systems and/or software applications 3a-o. In this embodiment, the computer system arrangement 20 is further comprising at least three adapters 23a-o, where each of the at least three adapters is configured for both performing data transformation and/or mapping between at least one parameter of an individual data model of a first of the at least three software applications 3a-o and at least one generic parameter of the computer system arrangement 20, and for invoking at least one business process based on an incoming request received from the first of the at least external systems and/or three software applications 3a-o and an outgoing request from within the computer system arrangement 20.

In embodiments, the computer system arrangement, e.g. an abstraction layer, information bus, or integration bus, is configured so that the execution of the at least one business process involves interaction with at least two other adapters 23a-o among the at least three adapters of the information bus.

In embodiments, each of the at least three adapters 23a-o are configured to invoke a plurality of business processes based on a single incoming or outgoing request received by the adapter 23a-o.

In embodiments, each of the at least three adapters 23a-o of the computer system arrangement 20 is configured to invoke a business process, which in turn is configured to invoke a rule function and where the rule function is configured to be invoked from within the invoked business process.

In embodiments of the technology disclosed, the rule functions are defined in a Rules engine in the computer system arrangement 20, e.g. an abstraction layer, information bus, are separated from the pure business processes defined in a business process engine, e.g. a Business Process Execution Engine (BPEE) 22, in the same computer system arrangement 20. The at least three of adapters 23a-o of the abstraction layer, or information bus 20, may then be configured to invoke a business process defined in the business process engine. The invoked business process is, in turn, configured to invoke at least one of a plurality of rule functions defined in the Rules engine. The at least one rule function, which is invoked from within the business process, then returns a value representing a business process branch among a plurality of business process options. The rule function may be executed with the purpose of determining the further execution of business processes by selecting which process branch to be executed next among different business process options. In embodiments, the rule function may in addition be configured to return a value representing a stop or error.

Separating the business rules, or rule functions, defined in the Rules Engine from the business processes defined in the business process engine, provides an improved ability to adjust business rules, or business rule parameters, without interfering with the business process flow. By separating the rule functions from the business processes, the amount of duplicated data and rules in the business processes defined in the business process engine is also reduced. This provides the further advantages that it is much easier to make changes to a business rule, or adjust a business rule parameter, and that the amount of integration and configuration needed to get the system operational after a change to a business rule, or business rule parameter, is lower. Thus, in this embodiment of the technology disclosed where the business rules, or rule functions, are separated from the pure business processes in the information bus, makes the process for making changes in the customer offering faster, less difficult and less costly. This embodiment of the technology disclosed also makes it less difficult to scale to large number of systems or to accommodate several operators needs in one system.

In embodiments, each of the at least three adapters of the information bus is configured to invoke a plurality of at least one of sequentially and in parallel executed business processes in the information bus based on one of a single incoming request received from one of the at least three software applications and a single outgoing request from the information bus.

In embodiments, each of the at least three adapters 23a-o of the computer system arrangement 20, e.g. an abstraction layer or information bus, is configured to invoke at least one business process in the computer system arrangement 20 based on one of a single incoming request received from one of at least three external systems and/or software applications and a single outgoing request from the computer system arrangement 20, where the at least one business process, when executed by the computer system arrangement 20, is configured to invoke a rule function from within the at least one business process and the rule function is configured to be executed by the computer system arrangement 20 with the purpose of determining the further execution of business processes by selecting which process branch to be executed next among different business process options.

In embodiments, a first adapter among the at least three adapters 23a-o is having a connection to a first external system and/or software application 3a-o among at least three external systems and/or software applications 3a-o and is configured to invoke a business process to initiate interaction with a plurality of other adapters 23a-o among the at least three adapters 23a-o, and wherein the plurality of other adapters are having connections to and configured for retrieving at least one of data and information from a second and a third external system and/or software application 3a-o different from the first external system and/or software application 3a-o based on a business process invoked by the first adapter following a single incoming request from the first external system and/or software application 3a-o which is received by the first adapter 23a-o.

In embodiments, the at least one business process invoked by the adapter is configured to invoke at least one additional business process to be executed.

In embodiments, each of the at least three adapters 23a-o of a computer system arrangement 20 is configured to perform mapping between a plurality of process IDs in the information bus based on a single incoming or outgoing request.

In embodiments, each of the at least three adapters 23a-o of a computer system arrangement 20 is configured to perform mapping between a process ID and a rule function ID, or business rule ID, based on a single incoming or outgoing request.

In embodiments, each of the at least three adapters 23a-o of a computer system arrangement 20 is configured to perform mapping between a plurality of process IDs in the computer system arrangement 20, or abstraction layer, based on a single incoming or outgoing request.

In embodiments, each of the at least three adapters 23a-o of a computer system arrangement 20, or abstraction layer, may be configured to be able to handle any communication protocols (e.g. TCP/IP, FTP/IP, SSH, Web Services, REST etc), communication link redundancy (fail over, load balancing etc), addressing translations (NAT etc), IP masquerading, encryptions (e.g. IP Sec) and/or operational status and alarm for the adapter itself (buffer overflow, timeouts) and/or the connected external system.

In embodiments, each of the at least three adapters 23a-o of a computer system arrangement 20, or abstraction layer, is configured to invoke a single first business process in the computer system arrangement 20 to be executed by a process execution engine 22 of the computer system arrangement 20 based on a single incoming request, and where the process execution engine 22 is further configured to execute at least one additional process which is invoked by the first business process.

In certain embodiments, the computer system arrangement 20, e.g. an abstraction layer or information bus, may comprise at least one adapter socket connected to each one of a plurality of application adapters which, in turn, are each connected to different external systems and/or software applications 3a-o.

In embodiments, the technology disclosed relates to a method for minimizing communication and integration complexity between at least three software applications 3a-o, where each of the at least three software applications 3a-o has an individual data model 7a-o defining an individual set of application parameters 70a-o, and where each of the at least three external systems and/or software applications 3a-o is having connections to at least one adapter 23a-o of a computer system arrangement 20, or integration bus 20, the computer system arrangement 20 is comprising at least three adapters 23a-o arranged to interpret between each of the at least three external systems and/or software applications 3a-o and to orchestrate incoming and outgoing requests from each of the at least three external systems and/or software applications 3a-o, the method comprising:
a. receiving, by one of the at least three adapters 23a-o, a request,
b. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
c. invoking, by the one of the at least three adapters 23a-o, at least one business process,

wherein the above steps of performing mapping and invoking the at least one business process are based on a request for a service received from one of the external systems and/or software applications 3a-o.

In embodiments, the technology disclosed relates to a method for minimizing communication and integration complexity between at least three external systems and/or software applications 3a-o, where each of the at least three external systems and/or software applications 3a-o has an individual data model 7a-o defining an individual set of application parameters 70a-o, and wherein each of the at least three software applications 3a-o is having connections to at least one adapter 23a-o of a computer system arrangement 20, the a computer system arrangement 20 is comprising at least three adapters 23a-o arranged to interpret between each of the at least three software applications 3a-o and to orchestrate incoming and outgoing requests from each of the at least three external systems and/or software applications 3a-o, the method comprising:
d. receiving, by one of the at least three adapters 23a-o, a request,
e. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
f. invoking, by the one of the at least three adapters 23a-o, at least one business process,

wherein the above steps of performing mapping and invoking the at least one business process are based on the same single request received from one of the external systems and/or software applications 3a-o or the same outgoing request.

In embodiments, the technology disclosed relates to a method for minimizing communication and integration complexity between at least three external systems and/or software applications 3a-o, wherein each of the at least three external systems and/or software applications 3a-o has an individual data model 7a-o each defining an individual set of application parameters 70a-o, and wherein each of the at least three external systems and/or software applications 3a-o is having connections to at least one adapter 23a-o of a computer system arrangement 20, or integration bus, the a computer system arrangement 20 is comprising at least three adapters 23a-o arranged to interpret between each of the at least three external systems and/or software applications 3a-o and to orchestrate incoming and outgoing requests from each of the at least three software external systems and/or applications 3a-o, the method comprising:
a. receiving, by one of the at least three adapters 23a-o, a request,
b. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
c. invoking, by the one of the at least three adapters 23a-o, at least one business process, wherein the above steps of performing mapping and invoking the at least one business process are based on the same single request received from one of the external systems and/or software applications 3a-o or the same outgoing request.

In embodiments, the technology disclosed relates to a method for minimizing communication and integration complexity between at least three external systems and/or software applications 3a-o, wherein each of the at least three external systems and/or software applications 3a-o has an individual data model 7a-o each defining an individual set of application parameters 70a-o, and wherein each of the at least three external systems and/or software applications 3a-o is having connections to at least one adapter 23a-o of a computer system arrangement 20, or integration bus, the a computer system arrangement 20 is comprising at least three adapters 23a-o arranged to interpret between each of the at least three external systems and/or software applications 3a-o and to orchestrate incoming and outgoing requests from each of the at least three software external systems and/or applications 3a-o, the method comprising:
a. receiving, by one of the at least three adapters 23a-o, a request,
b. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
c. invoking, by the one of the at least three adapters 23a-o, at least one business process, wherein the above steps of performing mapping and invoking the at least one business process are based on the same single request received from one of the external systems and/or software applications 3a-o or the same outgoing request, wherein the execution of the at least one business process involves interaction with at least two other adapters (23a-o) of the computer system (20).

In embodiments, the technology disclosed relates to a method for minimizing communication and integration complexity between at least three external systems and/or software applications 3a-o, wherein each of the at least three external systems and/or software applications 3a-o has an individual data model 7a-o each defining an individual set of application parameters 70a-o, and wherein each of the at least three external systems and/or software applications 3a-o is having connections to at least one adapter 23a-o of a computer system arrangement 20, or integration bus, the a computer system arrangement 20 is comprising at least three adapters 23a-o arranged to interpret between each of the at least three external systems and/or software applications 3a-o and to orchestrate incoming and outgoing requests from each of the at least three software external systems and/or applications 3a-o, the method comprising:
a. receiving, by one of the at least three adapters 23a-o, a request,
b. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
c. invoking, by the one of the at least three adapters 23a-o, at least one business process, wherein the above steps of performing mapping and invoking the at least one business process are based on the same single request received from one of the external systems and/or software applications 3a-o or the same outgoing request, said method further comprising invoking a plurality of business processes based on a single incoming or outgoing request received.

In embodiments, the technology disclosed relates to a method for minimizing communication and integration complexity between at least three external systems and/or software applications 3a-o, wherein each of the at least three external systems and/or software applications 3a-o has an individual data model 7a-o each defining an individual set of application parameters 70a-o, and wherein each of the at least three external systems and/or software applications 3a-o is having connections to at least one adapter 23a-o of a computer system arrangement 20, or integration bus, the a computer system arrangement 20 is comprising at least three adapters 23a-o arranged to interpret between each of the at least three external systems and/or software applications 3a-o and to orchestrate incoming and outgoing requests from each of the at least three software external systems and/or applications 3a-o, the method comprising:
a. receiving, by one of the at least three adapters 23a-o, a request,
b. performing, by the one of the at least three adapters 23a-o, mapping between at least one parameter of an individual data model of one of the at least three external systems and/or software applications 3a-o and at least one generic parameter among a set of generic parameters 61 defined by a generic information model 21 of the information bus 20, and
c. invoking, by the one of the at least three adapters 23a-o, at least one business process, wherein the above steps of performing mapping and invoking the at least one business process are based on the same single request received from one of the external systems and/or software applications 3a-o or the same outgoing request, further comprising invoking a plurality of at least one of sequentially and in parallel executed business processes in the computer system (20) based on said one of a single incoming request received from one of said at least three software applications (3a-o) and a single outgoing request from said computer system (20).

In embodiments, the technology disclosed relates to a method for minimizing communication and integration complexity between a plurality of external systems and/or software applications (3a-o), wherein each of said plurality of external systems and/or software applications (3a-o) has an individual data model (7a-o) each defining an individual set of data and/or application parameters (70a-o), and wherein each of said plurality of external systems and/or software applications (3a-o) is having connections to at least one adapter (23a-o) of an computer system (20), said computer system (20) is comprising a plurality of adapters (23a-o) arranged to interpret between each of the plurality of external systems and/or software applications (3a-o) and to orchestrate incoming and outgoing requests from each of the at least three software applications (3a-o) said method comprising:
a. receiving, at one of said plurality of adapters (23a-o), a request,
b. performing, by said one of said plurality of adapters (23a-o) and based on said request, data transformation and/or mapping between data and/or at least one parameter of an individual data model of one of the plurality of external systems and/or software applications (3a-o) and data and/or at least one generic parameter among a set of generic parameters (61) defined by the generic information model (21) of the information bus (20), and
c. invoking, by said one of said plurality of adapters (23a-o) and based on said same request, at least one business process,
wherein said steps of performing mapping/transformation of data and/or parameters and invoking the at least one business process are based on the same single request received from one of the plurality of external systems and/or software applications (3a-o), said method further comprising
d. invoking a rule function from within one of the at least one invoked business process,
wherein said rule function is executed with the purpose of determining the further execution of at least one business process by selecting which process branch to be executed next among different business process options.

In embodiments, the execution of the at least one business process according to the above-defined methods involves interaction with at least two other adapters 23a-o of the computer system arrangement 20.

In embodiments, the above-mentioned methods further comprising that the one of the at least three adapters 23a-o is invoking a plurality of business processes based on a single incoming or outgoing request received.

In embodiments, the above-mentioned methods further comprising that the business process invokes a rule function, where the rule function is invoked from within the invoked at least one business process.

In embodiments, the above-mentioned methods further comprising that the at least three adapters 23a-o invokes a plurality of at least one of sequentially and in parallel executed business processes in the computer system arrangement 20 based on one of a single incoming request received from one of the at least three software applications 3a-o and a single outgoing request from the computer system arrangement 20.

In embodiments, the above-mentioned methods further comprising the at least one business process, when executed, invokes a rule function from within the at least one business process, and where the rule function is executed with the purpose of determining the further execution of business processes by selecting which process branch to be executed next among different business process options.

In embodiments, the above-mentioned methods further comprising invoking a business process to initiate interaction with a plurality of other adapters having connections to and configured for retrieving at least one of data and information from other applications based on a single incoming or outgoing request received by the adapter 23a-o.

In embodiments, the above-mentioned methods further comprising the one of the at least three adapters 23a-o performs mapping between a process ID based on s single incoming or outgoing request.

In embodiments, the above-mentioned methods further comprising the one of the at least three adapters 23a-o performs mapping between a plurality of process IDs based on a single incoming or outgoing request.

In embodiments, the above-mentioned methods further comprising the one of the at least three adapters 23a-o performs mapping between a process ID and a rule function ID, or business rule

ID, based on the single incoming or outgoing request.

In embodiments, the business process executed by the computer system arrangement 20 may be synchronous, asynchronous or long synchronous.

In embodiments, the technology disclosed relates to a method and a computer system arrangement, e.g. a bus arrangement, or abstraction layer, having connections to each one of at least three external systems and/or software applications, where the bus is arranged to interpret between each application and to orchestrate incoming and outgoing requests from each of at least three external systems and/or software applications, where the at least three adapters are each configured to invoke a business process, which in turn is configured to invoke a rule function and where the rule function is configured to be invoked from within the invoked business process.

In embodiments, the technology disclosed relates to a method and a computer system arrangement, e.g. a bus arrangement, or abstraction layer, having connections to each one of at least three software applications, where the bus is arranged to interpret between each application and to orchestrate incoming and outgoing requests from each of at least three software applications, where each of the at least three adapters is configured to invoke a plurality of at least one of sequentially and in parallel executed business processes in the bus arrangement based on one of a single incoming request received from a software application and a single outgoing request from the bus arrangement.

In embodiments, the technology disclosed relates to a method and a computer system arrangement, e.g. a bus arrangement, or abstraction layer, having connections to each one of at least three external systems and/or software applications, where the bus is comprising at least three adapters configured for interpreting between the external systems and/or software applications and to orchestrate incoming and outgoing requests from each of the at least three external systems and/or software applications, where each of the at least three adapters is configured to invoke at least one business process in the computer system arrangement based on one of a single incoming request received from a software application and a single outgoing request from the computer system arrangement, where the at least one business process, when executed, invokes a rule function from within the at least one business process and the rule function is configured to be executed with the purpose of determining the further execution of business processes by selecting which process branch to be executed next among different business process options.

In embodiments, the technology disclosed relates to a method and a computer system arrangement 20, where the computer system arrangement is comprising at least three adapters which are further configured to handle the communication protocols (TCP/IP, FTP/IP, SSH, Web Services etc), the communication link redundancy (fail over, load balancing etc), addressing translations (NAT etc), IP masquerading, encryptions (IP Sec) and/or operational status and alarm for the adapter itself (buffer overflow, timeouts) and/or the connected external system, i.e. a software application.

In embodiments, the technology disclosed relates to a method and a computer system arrangement, e.g. a bus arrangement, or abstraction layer, having connections to each one of at least three external systems and/or software applications, where the computer system arrangement is arranged to interpret between each external system or application and to orchestrate incoming and outgoing requests from each of at least three software external systems and/or software applications, where each of the at least three adapters is configured to invoke at least one business process in the computer system arrangement based on one of a single incoming request received from an external system and/or software application and a single outgoing request from the computer system arrangement, where the at least one business process, when executed, invokes a rule function from within the at least one business process and the rule function is configured to determine, from a plurality of possible software implemented business processes, the selection of one additional second business process to be executed.

In embodiments, the technology disclosed relates to a method and a computer system arrangement, e.g. a bus arrangement, or abstraction layer, having connections to each one of at least three external systems and/or software applications, where the computer system arrangement, or bus, is arranged to interpret between each application and to orchestrate incoming and outgoing requests from each of at least three external systems and/or software applications, where each of the at least three adapters is configured to invoke a plurality of business processes based on a single incoming or outgoing request received.

In embodiments, each of the at least three adapters 23a-o is configured to invoke a single first process in the computer system arrangement, or bus arrangement 20, to be executed by a process execution engine 22 based on a single incoming request, wherein the process execution engine 22 is further configured to execute at least one additional process which is invoked by the first business process.

In embodiments, the technology disclosed relates to a method and a computer system arrangement, e.g. a bus arrangement, or abstraction layer, having connections to each one of at least three external systems and/or software applications, where the computer system arrangement, or bus, is arranged to interpret between each application and to orchestrate incoming and outgoing requests from each of at least three external systems and/or software applications, where a first adapter among the at least three adapters, which is connected to a first external system and/or software application, is configured to invoke a business process to initiate interaction with a plurality of other adapters in form of at least a second and third adapter having connections to and configured for retrieving at least one of data and information from a second and a third external system and/or software application based on a single incoming or outgoing request received by the first adapter.

In embodiments, the technology disclosed relates to a system which further includes a product database and configurator arranged to form a central part in a coherent product definition with prices and configuration parameters for each product.

In embodiments, the technology disclosed relates to a computer system (20) for minimizing communication and integration complexity between a plurality of external systems and/or software applications (3a-o), wherein each of said external systems and/or software applications (3a-o) has an individual data model (7a-o) each defining an individual set of application services and/or parameters (70a-o), said computer system (20) having connections (24a-o) to each one of said external systems and/or software applications (3a-o), wherein said computer system (20) is arranged to interpret between each of said external systems and/or software applications (3a-o) and to orchestrate incoming requests from each of said external systems and/or software applications (3a-o), said computer system (20) is further comprising a plurality of adapters (23a-o), wherein at least one of said plurality of adapters (23a-o) is configured to
a. perform data transformation and/or mapping between at least one parameter of an individual data model of at least one of said external systems and/or software applications (3a-o) and at least one generic parameter and/or data of the computer system (20), and
b. invoke at least one business process based on an incoming request received from one of said plurality of external systems and/or software applications (3a-o),

wherein said at least one of said plurality of adapters (23a-o) is further configured to identify a service and/or a business process in one of said plurality of external system and/or a software applications (3a-o) based on at least one of data and address information in an outgoing activity request generated from a business process initiated and/or invoked from within the computer system (20).

In embodiments, the above-mentioned computer system (20) is further configured so that the execution of the at least one business process based on said incoming request involves interaction with at least two other adapters (23a-o) among said plurality of adapters (23a-o) of the computer system (20).

In embodiments, at least one of the above-mentioned plurality of adapters (23a-o) is configured to invoke a plurality of business processes based on a single incoming request from one of said external systems and/or software applications (3a-o).

In embodiments, at least one of the above-mentioned plurality of adapters (23a-o) is configured to invoke a business process, which in turn is configured to invoke a rule function, and wherein the rule function is configured to be invoked from within the invoked business process.

In embodiments, each of the above-mentioned plurality of adapters (23a-o) is configured to invoke at least one business process in said computer system (20) based on a single incoming request received from one of said external systems and/or software applications (3a-o), wherein the at least one business process, when executed, is configured to invoke a rule function from within the at least one business process and the rule function is configured to be executed with the purpose of determining the further execution of at least one business process by selecting which process branch to be executed next among different business process options.

In embodiments, the technology disclosed relates to a computer system 20 for minimizing communication and integration complexity between a plurality of external systems and/or software applications 3a-o, wherein each of said external systems and/or software applications 3a-o has an individual data model 7a-o each defining an individual set of application services and/or parameters 70a-o, said computer system 20 having connections 24a-o to each one of said software applications or systems 3a-o, wherein said computer system 20 is arranged to interpret between each of said external systems and/or software applications 3a-o and to orchestrate incoming requests from each of said external systems and/or software applications 3a-o, said computer system 20 is further comprising at least three adapters 23a-o, wherein each of said at least three adapters 23a-o is configured for both performing
a. data transformation and/or mapping between at least one parameter of an individual data model of at least one of said external systems and/or software applications 3a-o and at least one generic parameter and/or data of the computer system 20, and for
b. invoking at least one business process based on an incoming request received from one of said plurality of external systems and/or software applications 3a-o, wherein each of said at least three adapters 23a-o is further configured to identify a service and/or a business process in one of said plurality of external system and/or a software applications 3a-o based on at least one of data and address information in an outgoing activity request generated from a business process initiated and/or invoked from within the computer system 20, and wherein said computer system can be referred to as at least one of an abstraction layer, a bus arrangement. an integration bus and an information bus.

In embodiments, the technology disclosed relates to a method for minimizing communication and integration complexity between a plurality of external systems and/or software applications 3a-o, wherein each of said plurality of external systems and/or software applications 3a-o has an individual data model 7a-o each defining an individual set of data and/or application parameters 70a-o, and wherein each of said plurality of external systems and/or software applications 3a-o is having connections to at least one adapter 23a-o of an computer system 20, said computer system 20 is comprising a plurality of adapters 23a-o arranged to interpret between each of the plurality of external systems and/or software applications 3a-o and to orchestrate incoming and outgoing requests from each of the at least three software applications 3a-o said method comprising:
a. receiving, at one of said plurality of adapters 23a-o, a request,
b. performing, by said one of said plurality of adapters 23a-o and based on said request, data transformation and/or mapping between data and/or at least one parameter of an individual data model of one of the plurality of external systems and/or software applications 3a-o and data and/or at least one generic parameter among a set of generic parameters 61 defined by the generic information model 21) of the computer system 20, and
c. invoking, by said one of said plurality of adapters 23a-o and based on said same request, at least one business process,
wherein said steps of performing mapping/transformation of data and/or parameters and invoking the at least one business process are based on the same single request received from one of the plurality of external systems and/or software applications 3a-o, and wherein said computer system 20 can be referred to as at least one of an abstraction layer, a bus arrangement. an integration bus and an information bus.

In embodiments, the technology disclosed relates to a method for minimizing communication and integration complexity between a plurality of external systems and/or software applications 3a-o, wherein each of said plurality of external systems and/or software applications 3a-o has an individual data model 7a-o each defining an individual set of data and/or application parameters 70a-o, and wherein each of said plurality of external systems and/or software applications 3a-o is having connections to at least one adapter 23a-o of an computer system 20, said computer system 20 is comprising a plurality of adapters 23a-o each arranged to interpret between at least one of the plurality of external systems and/or software applications 3a-o and to orchestrate incoming and outgoing requests from at least one of said at least three software applications 3a-o said method comprising:
d. receiving, at one of said plurality of adapters 23a-o, an outgoing activity request generated by a business process which execution is initiated by said computer system 20,
e. performing, by said one of said plurality of adapters 23a-o and based on said request, data transformation and/or mapping between at least one generic parameter among a set of generic parameters 61 defined by the generic information model 21 of the computer system 20 and a service and/or at least one parameter of an individual data model of one of the plurality of external systems and/or software applications 3a-o, and
f. requesting and/or invoking, by said one of said plurality of adapters 23a-o and based on said same activity request, at least one Application Programming Interface (API) and/or at least one business process to be executed by one of said external systems and/or software applications 3a-o,
wherein said step of performing mapping of data and/or parameters and said step of requesting/calling at least one API and/or invoking the at least one business process are both based on the same single request received from said outgoing activity request which is generated by a business process initiated and/or invoked from and/or executed within said computer system 20, and wherein said computer system 20 can be referred to as at least one of an abstraction layer, a bus arrangement. an integration bus and an information bus.

In embodiments, the technology disclosed relates to a method for minimizing communication and integration complexity between a plurality of external systems and/or software applications 3a-o, wherein each of said plurality of external systems and/or software applications 3a-o has an individual data model 7a-o each defining an individual set of data and/or application parameters 70a-o, and wherein each of said plurality of external systems and/or software applications 3a-o is having connections to at least one adapter 23a-o of an computer system 20, said computer system 20 is comprising a plurality of adapters 23a-o arranged to interpret between each of the plurality of external systems and/or software applications 3a-o and to orchestrate incoming and outgoing requests from each of the at least three software applications 3a-o said method comprising:
g. receiving, by an adapter socket communicatively coupled to a plurality of application adapters 23a-o, an outgoing activity request generated by a business process which execution is initiated by and within said computer system 20,
h. selecting, by said adapter socket and based on data, an identified service and/or address information in said activity request, one application adapter 23a-o, among said plurality of possible application adapters 23a-o, which in turn has an Application Programming Interface (API) and is communicatively coupled to an external system and/or software application 3a-o which is associated with data, an identified service and/or address information in said outgoing activity request,
i. performing, by said selected one of said plurality of adapters 23a-o and based on said request, data transformation and/or mapping between at least one generic parameter among a set of generic parameters 61 defined by the generic information model 21 of said application adapter or the computer system 20 and a service and/or at least one parameter of an individual data model of one of the plurality of external systems and/or software applications 3a-o, and
j. requesting and/or invoking, by said one of said plurality of adapters 23a-o and based on said same activity request, at least one Application Programming Interface (API) and/or at least one business process to be executed by one of said external systems and/or software applications 3a-o,

wherein said step of performing mapping of data and/or parameters and said step of requesting/calling at least one API and/or invoking said at least one business process are both based on the same single request received from said outgoing activity request which is generated by a business process initiated and/or invoked from and/or executed within said computer system 20.

In embodiments, the technology disclosed relates to a computer system arrangement for minimizing communication and integration complexity between a plurality of software applications, wherein at least a subset of these applications 3a-o has an individual data model 7a-o each defining an individual set of application parameters 70a-o, comprising a bus arrangement 20 having connections 24a-o to each one of the plurality of applications 3a-o, characterized in that the bus arrangement 20 is arranged to interpret between each application 3a-o and to orchestrate incoming and outgoing requests from each application 3a-o, the bus arrangement 20 including:
a business process defined by a business process management tool 25, 26,
a generic information model 21 defining a set of generic parameters 61 in relation to the application parameters 70a-o of each application 3a-o,
incoming and outgoing adapter 23a-o arranged to interconnect each connection 24a-o with the generic information model 21,
the adapters 23a-o together with the generic information model 21, in connection with an incoming request, arranged to map parameters 70a-o of that individual data model 7a-o to the generic parameters 61,
the adapters 23a-o being arranged to translate and to data map information at the incoming and outgoing requests and map between a business process ID in the bus arrangement 20 and the incoming and outgoing requests of the applications 3a-o to invoke the correct business process in the bus arrangement 20,
the bus arrangement 20 being arranged to transfer the generic parameters 61 together with the request to a process execution engine 22,
the process execution engine 22 being arranged to handle the request and to identify a corresponding adapter 23a-o to which the request was directed, and
using the corresponding adapter 23a-o together with the generic information model 21 to remap the request to the individual data model 7b of the application 3a-o to which the request was directed.

In embodiments, the computer system arrangement according to the technology disclosed is a bus arrangement or abstraction layer, which includes a generic information model defining a set of generic parameters in relation to the application parameters of each application. The bus arrangement, or abstraction layer, preferably comprises at least three adapters, where each of the at least three adapters is arranged for both performing mapping between at least one parameter of an individual data model and at least one generic parameter, and for invoking at least one business process based on at least one of a single request received from a software application and a single request from within the bus arrangement, and where the execution of the at least one business process involves interaction with at least two other adapters of the bus arrangement.

In embodiments, the abstraction layer, or bus arrangement, includes at least three adapters, each connected to at least one software application and arranged to perform data mapping by mapping parameters of individual data models of the plurality of software applications and further arranged to orchestrate incoming requests from a specific software application, and/or requests from within the bus arrangement, by invoking at least one business process involving a plurality of other adapters each connected to at least one application. In embodiments, at least one of the at least three adapters of the abstraction layer, e.g. a bus arrangement, is arranged to invoke a business process, which in turn is configured to invoke a rule function and where the rule function is configured to be invoked from within the invoked business process.

In certain embodiments, the technology disclosed includes a device arranged to transfer a mapped generic information model together with the request to a process execution engine, e.g. a business process execution engine, which includes a device arranged to handle the request to identify a corresponding adapter to which the request was directed, and using the corresponding adapter together with the generic information model to remap the request to the individual data model of the application to which it was directed.

In embodiments, the technology disclosed relates to a method for minimizing communication and integration complexity between at least three software applications, wherein each of the at least three software applications has an individual data model each defining an individual set of application parameters, where the computer system arrangement comprises a bus arrangement communicatively coupled, and/or having connections, to each one of the at least three software applications and further comprises at least three incoming and outgoing adapters arranged for interconnecting each connection with a generic information model defining a set of generic parameters in relation to the application parameters, the method comprising:
a. receiving, by a first adapter among the at least three incoming and outgoing adapters, one of a single incoming request received from a software application and a single outgoing request from within the bus arrangement;
b. performing, by the first adapter, data mapping between a first software application and at least one other software application among the at least three software applications, wherein the data mapping is performed by mapping between at least one parameter of at least one individual data model and at least one parameter among the generic parameters, or vice versa; and invoking, by the first adapter, a plurality of at least one of sequentially and in parallel executed business processes in the bus arrangement based on the one of a single incoming request received from a software application and a single outgoing request from the bus arrangement.

In embodiments, the technology disclosed relates to a method for minimizing communication and integration complexity between at least three software applications, wherein each of the at least three software applications 3a-o has an individual data model 7a-o each defining an individual set of application parameters 70a-o, the computer system arrangement comprises a bus arrangement 20 communicatively coupled and/or having connections 24a-o to each one of the at least three software applications 3a-o and comprising at least three incoming and outgoing adapters 23a-o arranged to interconnect each connection 24a-o with a generic information model 21 defining a set of generic parameters 61 in relation to the application parameters 70a, 70b, the method comprising:
a. receiving, by a first adapter among the at least three incoming and outgoing adapters 23a-o, one of a single incoming request received from a software application 3a-o and a single outgoing request from the bus arrangement 20;
b. performing, by the first adapter 23a-o, data mapping between a first software application 3a-o and at least one other software application among the at least three software applications 3a-o, wherein the data mapping is performed by mapping between at least one parameter of at least one individual data model 70a and at least one parameter among the generic parameters 61, or vice versa; and
c. invoking, by the first adapter 23a-o at least one business process in the bus arrangement 20 based on the one of a single incoming request received from a software application 3a-o and a single outgoing request from the bus arrangement 20, wherein the at least one business process, when executed, invokes a rule function from within the at least one business process and the rule function is configured to determine, from a plurality of possible software implemented business processes, the selection of one additional second business process to be executed.

In embodiments, the technology disclosed relates to a method and a computer system arrangement for minimizing communication and integration complexity between at least three software applications, wherein each of the at least three software applications 3a-o has an individual data model 7a-o each defining an individual set of application parameters 70a-o, the computer system arrangement comprises a bus arrangement 20 having connections 24a-o to each one of the at least three software applications 3a-o, the bus arrangement 20 further comprises:
at least three incoming and outgoing adapters 23a-o arranged to interconnect each connection 24a-o with a generic information model 21 defining a set of generic parameters 61 in relation to the application parameters 70a, 70b of each of the at least three software applications 3a-o, wherein each of the at least three adapters 23a-o is further configured to:
   a. perform, based on an incoming request, data mapping between at least one of the three software applications 3a-o and at least one other software application among the at least three software applications 3a-o, wherein the data mapping is performed by mapping parameters of at least one individual data model 70a to the generic parameters 61, or vice versa, and wherein each of the at least three adapters 23a-o is further configured to:
   b. invoke at least one business process in the bus arrangement 20 based on the same incoming request, wherein the invoked at least one business process, when executed, is configured to initiate interaction with a plurality of other adapters in form of at least a second and third adapter having connections to and configured for retrieving at least one of data and information from respective second and third software applications 3a-o based on a single incoming request received by a first adapter.

In embodiments, the technology disclosed relates to a method and a computer system arrangement for minimizing communication and integration complexity between at least three software applications, wherein each of the at least three software applications 3a-o has an individual data model 7a-o each defining an individual set of application parameters 70a-o, the computer system arrangement comprises a bus arrangement 20 having connections 24a-o to each one of the at least three software applications 3a-o, the bus arrangement 20 further comprises:
at least three incoming and outgoing adapters 23a-o arranged to interconnect each connection 24a-o with a generic information model 21 defining a set of generic parameters 61 in relation to the application parameters 70a, 70b of each of the at least three software application 3a-o, wherein each of the at least three adapters 23a-o is further configured to:
   a. perform, based on an outgoing request from the bus arrangement 20, data mapping between at least one of the three software applications 3a-o and at least one other software application among the at least three software applications 3a-o, wherein the data mapping is performed by mapping between parameters of at least one individual data model 70a and at least one of the generic parameters 61, and wherein each of the at least three adapters 23a-o is further configured to:
   b. invoke at least one business process in the bus arrangement 20 based on the same outgoing request, wherein at least one of the at least one business process is invoking a rule function from within the at least one of the at least one business process, and wherein the at least one business process involves the interaction with a plurality of other adapters in form of at least a second and third adapter having connections to and configured for retrieving at least one of data and information from respective second and third software applications 3a-o based on the single outgoing request from the bus arrangement 20.

In embodiments, the technology disclosed relates to a method and a computer system arrangement for minimizing communication and integration complexity between at least three software applications, wherein each of the at least three software applications 3a-o has an individual data model 7a-o each defining an individual set of application parameters 70a-o, the computer system arrangement comprises a bus arrangement 20 having connections 24a-o to each one of the at least three software applications 3a-o, the bus arrangement 20 further comprises:
at least three incoming and outgoing adapters 23a-o arranged to interconnect each connection 24a-o with a generic information model 21 defining a set of generic parameters 61 in relation to the application parameters 70a, 70b of each of the at least three software application 3a-o, wherein each of the at least three adapters 23a-o is configured to:
a. perform, based on a single incoming request, data mapping between at least one of the three software application 3a-o and at least one other software application among the at least three software applications 3a-o, wherein the data mapping is performed by mapping between at least one parameter of at least one individual data model 70a to at least one parameter of the generic parameters 61;
b. invoke at least one software implemented business process in the bus arrangement 20 based on the same incoming request, wherein each of the at least three adapters 23a-o is further configured to handle the communication protocols, the communication link redundancy, addressing translations, encryptions and/or operational status and alarm for at least one of the adapter itself and the connected external system,

In embodiments, the technology disclosed relates to a method and a computer system arrangement for minimizing communication and integration complexity between at least three software applications, wherein each of the at least three software applications 3a-o has an individual data model 7a-o each defining an individual set of application parameters 70a-o, the computer system arrangement comprises a bus arrangement 20 having connections 24a-o to each one of the at least three software applications 3a-o, the bus arrangement 20 further comprises at least three incoming and outgoing adapters 23a-o arranged to interconnect each connection 24a-o with a generic information model 21 defining a set of generic parameters 61 in relation to the application parameters 70a, 70b of each of the at least three software application 3a-o, wherein a first of the at least three adapters 23a-o is configured to:
perform, based on an incoming request, data mapping between at least one of the three software applications 3a-o and at least one other software application among the at least three software applications 3a-o, wherein the data mapping is performed by mapping at least one parameter of at least one individual data model 70a to at least one parameter of the generic parameters 61, or vice versa, and is further configured to:
invoke at least one business process in the bus arrangement 20 based on the same incoming request, wherein the invoked at least one business process, when executed, interacts with a plurality of other adapters in form of at least a second and third adapter having connections to and configured for retrieving at least one of data and information from respective second and third software applications 3a-o based on a single incoming request received by a first adapter.

In embodiments, the technology disclosed relates to a method and a computer system arrangement for minimizing communication and integration complexity between at least three software applications, wherein each of the at least three software applications 3a-o has an individual data model 7a-o each defining an individual set of application parameters 70a-o, the computer system arrangement comprises a bus arrangement 20 having connections 24a-o to each one of the at least three software applications 3a-o, the bus arrangement 20 further comprises:
at least three incoming and outgoing adapters 23a-o arranged to interconnect each connection 24a-o with a generic information model 21 defining a set of generic parameters 61 in relation to the application parameters 70a, 70b of each of the at least three software application 3a-o, wherein each of the at least three adapters 23a-o is configured to both:
   a. perform, based on an incoming request, data mapping between at least one of the three software application 3a-o and at least one other software application among the at least three software applications 3a-o by mapping parameters of at least one individual data model 70a to the generic parameters 61, and
   b. invoke at least one business process in the bus arrangement 20 based on the same incoming request, wherein the at least one business process, when executed, invokes a rule function from within the at least one business process and the rule function is configured to determine, from a plurality of possible software implemented business processes, the selection of one additional second business process to be executed.

The technology disclosed relates to methods and a computer system arrangement for minimizing communication and integration complexity between a plurality of software applications having each an individual data model defining an individual set of application parameters. In embodiments, the technology disclosed relates to a method and a bus arrangement, or abstraction layer, having connections to each one of a plurality of software applications, where the bus is arranged to interpret between each application and to orchestrate incoming and outgoing requests from each application and where the bus arrangement comprises at least three adapters, each of the three adapters having connection(s) to at least one software application and is further configured for invoking a plurality of at least one of sequentially and in parallel executed business processes in the bus arrangement 20 based on the one of a single incoming request received from a software application 3a-o and a single outgoing request from the bus arrangement 20.

The technology disclosed relates to methods and a computer system arrangement for minimizing communication and integration complexity between a plurality of software applications having each an individual data model defining an individual set of application parameters. In embodiments, the technology disclosed relates to a method and a bus arrangement, or abstraction layer, having connections to each one of a plurality of software applications, where the bus is arranged to interpret between each application and to orchestrate incoming and outgoing requests from each application and where the bus arrangement comprises at least three adapters, each of the three adapters having connection(s) to at least one software application and is further configured for invoking at least one business process in the bus arrangement 20 based on one of a single incoming request received from a software application 3a-o and a single outgoing request from the bus arrangement 20, wherein the at least one business process, when executed, is configured to invoke a rule function from within the at least one business process, and wherein the rule function, when executed, is configured to determine, from a plurality of possible software implemented business processes, the selection of one additional second business process to be executed.

The technology disclosed relates to methods and a computer system arrangement for minimizing communication and integration complexity between a plurality of software applications having each an individual data model defining an individual set of application parameters. In embodiments, the technology disclosed relates to a method and a bus arrangement, or abstraction layer, having connections to each one of a plurality of software applications, where the bus is arranged to interpret between each application and to orchestrate incoming and outgoing requests from each application and where the bus arrangement comprises at least three adapters, each of the three adapters having connection(s) to at least one software application and is further configured for invoking at least one business process in the bus arrangement 20 based on one of a single incoming request received from a software application 3a-o and a single outgoing request from the bus arrangement (20), wherein the at least one business process, when executed, invokes a rule function from within the at least one business process, and wherein the rule function determines, from a plurality of possible software implemented business processes, the selection of one additional second business process to be executed.

A computer system arrangement for minimizing communication and integration complexity between a plurality of software applications having each an individual data model defining an individual set of application parameters, includes an abstraction layer, e.g. a bus arrangement, having connections to each one of the plurality of applications, the bus being arranged to interpret between each application and to orchestrate incoming and outgoing requests from each application. The abstraction layer, or bus arrangement, includes at least three adapters, each connected to at least one software application and arranged to perform data mapping by mapping parameters of individual data models of the plurality of software applications and further arranged to orchestrate incoming requests from a specific application by invoking at least one business process involving a plurality of other adapters each connected to at least one application. In embodiments, at least one of the adapters of the abstraction layer, e.g. a bus arrangement, is arranged to initiate a business process which in turn is configured to invoke a rule function of a Rules Engine.

In certain embodiments, the computer system arrangement, includes an abstraction layer, e.g. a bus arrangement, having connections to each one of the plurality of applications, the bus being arranged to interpret between each application and to orchestrate incoming and outgoing requests from each application, the bus arrangement including, a generic information model defining a set of generic parameters in relation to the application parameters of each application, an adapter together with the generic information model, in connection with an incoming request, arranged to map parameters of that individual data model to the generic parameters, a device arranged to transfer the mapped generic information model together with the request to a process execution engine, which includes a device arranged to orchestrate incoming requests from handle the request to identify a corresponding adapter to which the request was directed, and using the corresponding adapter together with the generic information model to remap the request to the individual data model of the application to which it was directed. The abstraction layer, or bus arrangement, includes at least three adapters, each further arranged to orchestrate incoming requests from a specific application by invoking at least one business process involving a plurality of other adapters each connected to at least one application. In embodiments, at least one of the adapters of the abstraction layer, e.g. a bus arrangement, is arranged to initiate a business process which is configured to invoke a rule function of a Rules Engine.

In embodiments, the technology disclosed includes at least one product configurator and database, which includes definitions of all products that the company offers. This may be a stand-alone system or possibly a part of some other sub-system. In embodiments, a stand-alone system which is separated from e.g. CRM and CSA systems may be used. The product configuration may then be handled using a product configurator application. In embodiments, the product database may then be configured to act as a master database for all products and contains product information, relations and configurations from the customer target and sales channel level all the way down to the technical services that are implemented in the network. It then contains all technical information as well as price information. In embodiments, the product database may also be configured to store all business as well as technical rules related to each and every product and offering. An illustration of the typical structure of a product definition is illustrated in FIG. 7, which also shows how different parts of the organization and the IT systems relate to the product definitions.

Finally, the subsystems used to illustrate the technology disclosed are just examples. There could be more or fewer subsystems and they might be divided in different ways. There may for instance be a combined CRM, CSA system, and product configurator. Or, there may be several systems involved in the same functions. One CSA may be used for a subsidiary in one country and another for another country.

### BRIEF DESCRIPTION OF DRAWINGS

Preferred embodiments of a computer system arrangement, CSA, according to the technology disclosed will be described more in detail below with reference to the accompanying drawings wherein:

FIG. 1 shows the prior art, wherein a computer system arrangement with the integrations necessary to combine a typical set of subsystems used by an operator.

FIG. 2 shows a known principle for integrating subsystems by using an integration bus to facilitate the communication between the different subsystems. Extensive integration is still required to adapt the data between each origin and destination system.

FIG. 3 shows a known structure for an information model (example from the association TM Forum, TeleManagement Forum). It is furthermore known that adherence to such a common information model can simplify exchange of data between subsystems.

FIG. 4a shows a preferred version of the technology disclosed, using an information model as an inherent part of the bus.

FIG. 4b shows another version of the technology disclosed, where the information model is used in an external system through which all information will pass. In this case, the information bus itself is a conventional implementation but used in a new context, since it adapts the information to the external system with the translation to/from the common information model.

FIG. 4c shows yet another version of a computer system arrangement according to the technology disclosed where two different integration buses are used together with an external system that uses the technical information model according to the technology disclosed.

FIG. 4d shows yet another version of a computer system arrangement according to the technology disclosed where two different integration buses are used with a firewall device connected therebetween.

FIG. 5 shows the relationships between information models in the bus and in the organization.

FIG. 6 shows a typical implementation of the computer system arrangement according to the technology disclosed using components available on the market.

FIG. 7 shows how for instance a product definition is built up and how it relates to different parts of the organization and different subsystems.

FIG. 8 shows schematically process relationships.

FIG. 9 shows schematically data mapping of address fields between two different applications and the generic data model.

FIG. 10 shows schematically an embodiment of the computer system arrangement according to the technology disclosed applied for handling of pre-payment and real-time billing and credit checking.

FIG. 11 shows an embodiment of the computer system arrangement according to the technology disclosed applied for handling of micro-payments for a variety of purposes.

FIG. 12a shows an embodiment of the computer system arrangement according to the technology disclosed applied in a Smart Energy Grid to connect a variety of units and systems with different functions.

FIG. 12b shows an embodiment similar to FIG. 12a of the computer system arrangement according to the technology disclosed, but where the Smart Metering device itself is made up of a home or small business bus.

FIG. 13 shows an embodiment of the computer system arrangement according to the technology disclosed, illustrating an Intelligent Traffic System where some of the systems may be mobile, using a wireless radio communication system for the communication.

FIG. 14 shows an example of a system in accordance with the technology disclosed to describe steps that may be used to add a function/application to it.

FIG. 15 shows the example of FIG. 14 after a new function/application has been added.

FIG. 16 shows a schematic detail view of an adapter in accordance with the technology disclosed.

FIG. 17 shows an embodiment of the computer system arrangement according to the technology disclosed, illustrating an abstraction layer, or bus arrangement, according to an embodiment of the technology disclosed where the rule functions, defined in a Rules engine, are separated from the business processes defined in a business process engine.

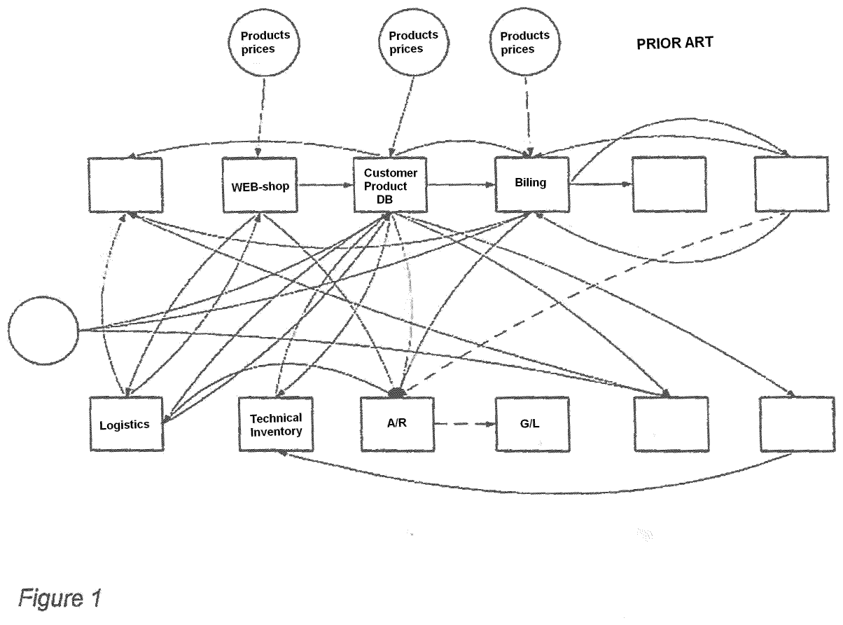

FIG. 1 8 shows the internal architecture and structure of the abstraction layer, or computer system, comprising three application adapters, “Application Specific Adapters” and an adapter socket, “CRM Adapter Socket”.

FIG. 19 illustrates an example embodiment of the structure and the role an abstraction layer may have in accordance with embodiments of the technology disclosed.

FIG. 20 illustrates the typical functions of an adapter of the computer system in accordance with embodiments of the technology disclosed.

FIG. 21 is an Illustration of a dashboard where the state of the Abstraction Layer can be monitored in accordance with embodiments of the technology disclosed.

FIG. 22 illustrates examples of Artificial Intelligence (AI) and O&M model interactions in the Abstraction Layer in accordance with embodiments of the technology disclosed.

### DETAILED DESCRIPTION

In the drawings, similar details are denoted with the same reference number throughout the different embodiments. In the various embodiments of the computer system arrangement, CSA, according to the technology disclosed the different “boxes”/subsystems are denoted. The “boxes”/subsystems shown in the drawings are by way of example only and can within the scope of the technology disclosed be arranged in any other way/combination.

For instance, the number of “boxes”/subsystems can be less or more than the number shown in the drawings.

A business process is in this disclosure a program implemented in hardware and/or software which is executed on a computer with the purpose of automatically handling business and/or operational tasks.

A rule function is in this disclosure a program implemented in hardware and/or software which is executed on a computer with the purpose of determining the further execution of business processes by selecting which process branch to be executed next among different business process options. In certain embodiments, a rule function may be a decision tree implemented in hardware and/or software.

A business process may comprise rules but, in this disclosure, a rule function is different from a rule in that it separates the branch selection from the business process with the purpose of simplifying the business process. In different embodiments described in this disclosure, a rule function may also be re-used several times in the same business process and by several separate business processes. In certain embodiments, a rule function may be configured to return different answers depending on values in calling arguments, depending on e.g. a decision tree.

A business process engine typically refers to an application that focuses on the (pure) execution of processes. The processes to be executed, i.e. the pre-structured sequence of individual activities, must be defined accordingly beforehand. When actually running the process so defined, the business process engine simply processes all activities and their “connections”, i.e. the transitions from one activity to the next. In contrast to the process definition, the processes currently in execution are called process instances. In certain embodiments, the business process may be configured to take different steps, call other processes etc, depending on decisions made by rules.

Activities typically differentiate between human activities, often called tasks, and machine activities, which are activities that are again performed by another program, program part or module of another application.

In this disclosure, an adapter is configured to invoke business processes at interactions between business processes in the abstraction layer and external systems. In this disclosure, the adapter is configured to handle both data transformation and business process ID mapping.

By the expression “a rule function being invoked from within a business process” is in this disclosure meant that the business process calls or activates a rule function with the necessary data for the rule function to return a value representing a business process branch among a plurality of business process options. In certain embodiments of the technology disclosed, a rule function may in addition be configured to return a value representing a stop or error.

According to certain aspects of the technology disclosed, a business process engine (BPE) is a software framework that enables the execution and maintenance of business process workflows. It provides business process interaction and communication between different data/process sources spread across one or more IT applications and services. BPE then automates linking processes and their activities in an enterprise IT environment. According to these aspects of the technology disclosed, BPE is a business process management (BPM) solution component typically used to oversee the technical architecture of business process integration, interlinking and inter-processing.

According to certain aspects of the technology disclosed, the BPE dynamically monitors and adjusts changes applied to data, as well as associated processes and process workflows. A BPE may also be used to create new business processes, and deployment capability for all connected applications without disruption or downtime.

According to certain aspects of the technology disclosed, a business rules engine is typically a program implemented in hardware or software that executes one or more business rules in a runtime production environment. In different aspects of the technology disclosed, the rules may come from legal regulation, company policy, e.g. that a customer who spend more than $100 at one time will receive a 10% discount, or other sources. A business rule system may then enable these company policies and other operational decisions to be defined, tested, executed and maintained separately from application code. In embodiments, rule engines support rules, facts, priority (score), mutual exclusion, preconditions, and other functions.

According to certain aspects of the technology disclosed, rule engine software may be provided as a component of a business rule management system which, among other functions, provides the ability to: register, define, classify, and manage all the rules, verify consistency of rules definitions, define the relationships between different rules, and relate some of these rules to IT applications that are affected or need to enforce one or more of the rules.

According to embodiments of the technology disclosed, a rules engine, or inference engine, may serve as pluggable software components which execute business rules that a business rules approach has externalized or separated from application code. This externalization or separation allows business users to modify the rules without the need for IT intervention. The system as a whole becomes more easily adaptable with such external business rules, but this does not preclude the usual requirements of testing. In any application, business rules often change more frequently than other processes or parts of the application code. In various embodiments of the technology disclosed, an adapter may in addition also be configured to handle the communication protocols (TCP/IP, FTP/IP, SSH, Web Services etc), the communication link redundancy (fail over, load balancing etc), addressing translations (NAT etc), IP masquerading, encryptions (IP Sec) and/or operational status and alarm for the adapter itself (buffer overflow, timeouts) and/or the connected external system.

Network address translation (NAT) is a method of remapping one IP address space into another by modifying network address information in the IP header of packets while they are in transit across a traffic routing device. The technique was originally used as a shortcut to avoid the need to readdress every host when a network was moved. It has become a popular and essential tool in conserving global address space in the face of IPv4, or IPv6, address exhaustion. One Internet-routable IP address of a NAT gateway can be used for an entire private network.

IP masquerading is a technique that hides an entire IP address space, usually consisting of private IP addresses, behind a single IP address in another, usually a public address space. The address that have to be hidden is changed into a single (public) IP address as “new” source address of the outgoing IP packet so it appears as originating not from the hidden host but from the routing device itself. Because of the popularity of this technique to conserve IPv4 or IPv6 address space, the term NAT has become virtually synonymous with IP masquerading.

As network address translation modifies the IP address information in packets, it has serious consequences on the quality of Internet connectivity and requires careful attention to the details of its implementation. NAT implementations vary widely in their specific behaviour in various addressing cases and their effect on network traffic. The specifics of NAT behaviour are not commonly documented by vendors of equipment containing NAT implementations.

The technology disclosed relates to methods and a computer system arrangement for minimizing communication and integration complexity between a plurality of software applications having each an individual data model defining an individual set of application parameters. In embodiments, the technology disclosed relates to a method and a bus arrangement, or abstraction layer, having connections to each one of at least three software applications, where the bus is arranged to interpret between each application and to orchestrate incoming and outgoing requests from each of the at least three software applications.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where each of the at least three adapters is arranged for both performing mapping between at least one parameter of an individual data model and at least one generic parameter, and for invoking at least one business process based on at least one of a single request received from a software application and a single request from within the bus arrangement. In embodiments, the execution of the at least one business process involves interaction with at least two other adapters of the bus arrangement.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where the at least three adapters are each configured to invoke a business process, which in turn is configured to invoke a rule function and where the rule function is configured to be invoked from within the invoked business process.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where each of the at least three adapters is configured to invoke a plurality of at least one of sequentially and in parallel executed business processes in the bus arrangement based on one of a single incoming request received from a software application and a single outgoing request from the bus arrangement.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where each of the at least three adapters is configured to invoke at least one business process in the bus arrangement based on one of a single incoming request received from a software application and a single outgoing request from the bus arrangement, where the at least one business process, when executed, invokes a rule function from within the at least one business process and the rule function is configured to be executed with the purpose of determining the further execution of business processes by selecting which process branch to be executed next among different business process options.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where each of the at least three adapters is configured to invoke at least one business process in the bus arrangement based on one of a single incoming request received from a software application and a single outgoing request from the bus arrangement, where the at least one business process, when executed, invokes a rule function from within the at least one business process and the rule function is configured to determine, from a plurality of possible software implemented business processes, the selection of one additional second business process to be executed.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where each of the at least three adapters is configured to invoke a plurality of business process based on a single incoming or outgoing request received.

In embodiments, the technology disclosed relates to a method and a bus arrangement, or abstraction layer, having connections to each one of at least three software applications, where the bus is arranged to interpret between each application and to orchestrate incoming and outgoing requests from each of at least three software applications, where a first adapter among the at least three adapters, which is connected to a first software application, is configured to invoke a business process to initiate interaction with a plurality of other adapters in form of at least a second and third adapter having connections to and configured for retrieving at least one of data and information from a second and third software applications based on a single incoming or outgoing request received by the first adapter.

In embodiments, the technology disclosed relates to a computer system arrangement for minimizing communication and integration complexity between a plurality of software applications, wherein at least a subset of these applications 3a-o has an individual data model 7a-o each defining an individual set of application parameters 70a-o, comprising a bus arrangement 20 having connections 24a-o to each one of the plurality of applications 3a-o, characterized in that the bus arrangement 20 is arranged to interpret between each application 3a-o and to orchestrate incoming and outgoing requests from each application 3a-o, the bus arrangement 20 including:
a business process defined by a business process management tool 25, 26,
a generic information model 21 defining a set of generic parameters 61 in relation to the application parameters 70a-o of each application 3a-o,
incoming and outgoing adapters 23a-o arranged to interconnect each connection 24a-o with the generic information model 21,
the adapter 23a-o together with the generic information model 21, in connection with an incoming request, arranged to map parameters 70a-o of that individual data model 7a-o to the generic parameters 61,
the adapter 23a-o being arranged to translate and to data map information at the incoming and outgoing requests and map between a business process ID in the bus arrangement 20 and the incoming and outgoing requests of the applications 3a-o to invoke the correct business process in the bus arrangement 20,
the bus arrangement 2 being arranged to transfer the generic parameters 61 together with the request to a process execution engine 22,
the process execution engine 22 being arranged to handle the request and to identify a corresponding adapter 23a-o to which the request was directed, and
using the corresponding adapter 23a-o together with the generic information model 21 to remap the request to the individual data model 7b of the application 3a-o to which the request was directed.

In embodiments, the technology disclosed relates to a computer system arrangement for minimizing communication and integration complexity between a plurality of software applications, wherein at least a subset of these applications 3a-o has an individual data model 7a-o each defining an individual set of application parameters 70a-o, comprising a bus arrangement 20 having connections 24a-o to each one of the plurality of applications 3a-o, characterized in that the bus arrangement 20 is arranged to interpret between each application 3a-o and to orchestrate incoming and outgoing requests from each application 3a-o, the bus arrangement 20 including:
a. a business process defined by a business process management tool 25, 26,
b. a generic information model 21 defining a set of generic parameters 61 in relation to the application parameters 70a-o of each application 3a-o,
c. incoming and outgoing adapters 23a-o arranged to interconnect each connection 24a-o with the generic information model 21,
d. the adapter 23a-o together with the generic information model 21, in connection with an incoming request, arranged to map parameters 70a-o of that individual data model 7a-o to the generic parameters 61,
e. the adapter 23a-o being arranged to translate and to data map information at the incoming and outgoing requests and map between a business process ID in the bus arrangement 20 and the incoming and outgoing requests of the applications 3a-o to invoke the correct business process in the bus arrangement 20,
f. the bus arrangement 20 being arranged to transfer the generic parameters 61 together with the request to a process execution engine 22,
g. the process execution engine 22 being arranged to handle the request and to identify a corresponding adapter 23a-o to which the request was directed, and
h. using the corresponding adapter 23a-o together with the generic information model 21 to remap the request to the individual data model 7b of the application 3a-o to which the request was directed, wherein the bus arrangement 20 is further comprising means configured to transfer the mapped generic information model 6 together with a single request from an application 3a-o to a process execution engine, and wherein the process execution engine 22 is configured to execute a plurality of business processes in the bus arrangement 20 in response to the single incoming request.

In embodiments, the adapter 23a-o is configured to invoke a plurality of processes in the bus arrangement 20 to be executed by the process execution engine 22 based on the single incoming request.

In embodiments, the technology disclosed relates to a computer system arrangement for minimizing communication and integration complexity between a plurality of software applications, wherein at least a subset of these applications 3a-o has an individual data model 7a-o each defining an individual set of application parameters 70a-o, comprising a bus arrangement 20 having connections 24a-o to each one of the plurality of applications 3a-o, characterized in that the bus arrangement 20 is arranged to interpret between each application 3a-o and to orchestrate incoming and outgoing requests from each application 3a-o, the bus arrangement 20 including:
a. a business process defined by a business process management tool 25, 26,
b. a generic information model 21 defining a set of generic parameters 61 in relation to the application parameters 70a-o of each application 3a-o,
c. incoming and outgoing adapter 23a-o arranged to interconnect each connection 24a-o with the generic information model 21,
d. the adapter 23a-o together with the generic information model 21, in connection with an incoming request, arranged to map parameters 70a-o of that individual data model 7a-o to the generic parameters 61,
e. the adapter 23a-o being arranged to translate and to data map information at the incoming and outgoing requests and map between a business process ID in the bus arrangement 20 and the incoming and outgoing requests of the applications 3a-o to invoke the correct business process in the bus arrangement 20,
f. the bus arrangement 20 being arranged to transfer the generic parameters 61 together with the request to a process execution engine 22,
g. the process execution engine 22 being arranged to handle the request and to identify a corresponding adapter 23a-o to which the request was directed, and
h. using the corresponding adapter 23a-o together with the generic information model 21 to remap the request to the individual data model 7b of the application 3a-o to which the request was directed.

In embodiments, the technology disclosed relates to a computer system arrangement for minimizing communication and integration complexity between a plurality of software applications, wherein at least a subset of these applications 3a-o has an individual data model 7a-o each defining an individual set of application parameters 70a-o, comprising a bus arrangement 20 having connections 24a-o to each one of the plurality of applications 3a-o, the bus arrangement 20 is arranged to interpret between each application 3a-o and to orchestrate requests from each application 3a-o, the bus arrangement 20 including:
a business process management tool 25, 26 configured to define a plurality of business processes,
a generic information model 21 defining a set of generic parameters 61 in relation to the application parameters 70a-o of each application 3a-o, and wherein the generic information model 21 is configured to remap the request to the individual data model 7b of the application 3a-o to which the request was directed,
incoming and outgoing adapter 23a-o arranged to interconnect each connection 24a-o with the generic information model 21, the adapter 23a-o is further configured to map parameters 70a-o of that individual data model 7a-o to the generic parameters 61 and to map an incoming request to a business process ID in the bus arrangement 20,
process execution engine 22 being arranged to execute a process based on the request and to identify a corresponding adapter 23a-o to which the request was directed,

wherein the bus arrangement 20 is further comprising means configured to transfer the mapped generic information model 6 together with a single request from an application 3a-o to a process execution engine, and wherein the process execution engine 22 is configured to execute a plurality of business processes in the bus arrangement 20 in response to the single incoming request.

In embodiments, the adapter 23a-o is configured to invoke a single first process in the bus arrangement 20 to be executed by the process execution engine 22 based on the single incoming request, and wherein the process execution engine 22 is further configured to execute at least one additional process which is invoked by the first process.

Summary of advantages that may be achieved (one of them, some of them or all of them) in accordance with the above-mentioned embodiments of the technology disclosed, compared to previous solutions, include:
Cheaper to build because fewer integrations between subsystems are required when the number of subsystems that need integration exceed 3.
Fast and easy setup, excellent time to market.
Can make use of open source and Commercial Off-The Shelf (COTS), when available.
Suitable for implementation of consistent product configurations.
Faster to change—much easier to replace systems or to introduce new services.
Smaller risk of mistakes and simpler troubleshooting/fault isolation.
Less costly to maintain because of fewer interfaces.
Everything is connected, no need for duplication.
Scales from small to large implementations.
Adapted for AI/machine learning/machine reasoning introduction.
Flexible and modularized, can fit any need.
Different views of data are brought together.
The linear scalability in integration complexity makes it possible to handle a very large number of subsystems which is in particular beneficial for the following businesses:
   Complex organizations (such a large variety of customer types, products, networks, product packages, service providers, technologies, countries, etc.)
   Organizations present in several countries with a mix of centralized and local IT support systems.
   An IT outsourcing business offering outsourced IT services to several operators that sometimes have similar applications, sometimes different.
It is possible for anyone to overview how the concepts they use in their daily work are reflected in the IT support system.
No integrated system need to know anything about any other system, or even the existence of them. This means that they are very easily replaced. When trying to replace an integrated system, the critical part that is difficult to replace is the integrations themselves, meaning that, as long as the operator can control these, it is fairly simple to e.g. replace an aging subsystem with a more modern one, or to replace one outsourcing partner with another. This is because replacement of one such system only requires a new integration to the information bus and does not affect the integrations to the other systems. In the event the bus itself needs replacement, the number of integrations to introduce a new bus is still far below the complexity of making substantial changes in conventional systems due to the lower number of integrations. This mitigates the risk of supplier lock-in.
A replacement or introduction of a system can be done, without closing down any existing functions, systems or processes
Redundancies can be added and maintained seamlessly and may be easily automated

Sectors in need of the improved solution according to the technology disclosed, include, but are not limited to:
Telecom operators/service providers
Smart energy and Smart homes
Smart cities and Smart vehicles
Bank and Finance
Public transport
Healthcare
Manufacturing & Retail
Logistics and resource management

Industrial operations suitable for implementation of the technology disclosed include, but is not limited to:
Alarm, location, facility access and process control
Integration at two different municipal utility infrastructure sites
Cloud based solutions
Internet of Things (IoT) solutions
Initial solution in operation and additional integrations added continuously

Smart city implementation of the technology disclosed include, but is not limited to:
Parking app for parking location
Integration with map app
Integration with different venues
In production in several countries
Cloud based implementations
Internet of Things (IoT) implementations

FIG. 1 illustrates a known computer system arrangement of this kind having the integrations necessary to combine a typical set of subsystems used by an operator. It is to be noted that product prices in this example could be inserted in several places. Each line between subsystems illustrates a need to communicate information and signals between the subsystems, initiated by one side or both sides. In order to make such communication possible, various adaptations between supported physical interfaces, logical interfaces, buffering, etc. is necessary. For instance, it may be necessary to transform units, formats, etc. It is also necessary for each system to know exactly from what other subsystem to retrieve information. For instance, the address may be fetched from one subsystem, whereas the telephone number may be fetched from another. The address may be in three lines with a country code that needs to be translated to a country name etc. Each such communication can also suffer from errors that need to be handled appropriately. This development activity and testing is referred to as “integration” between subsystems in this application.

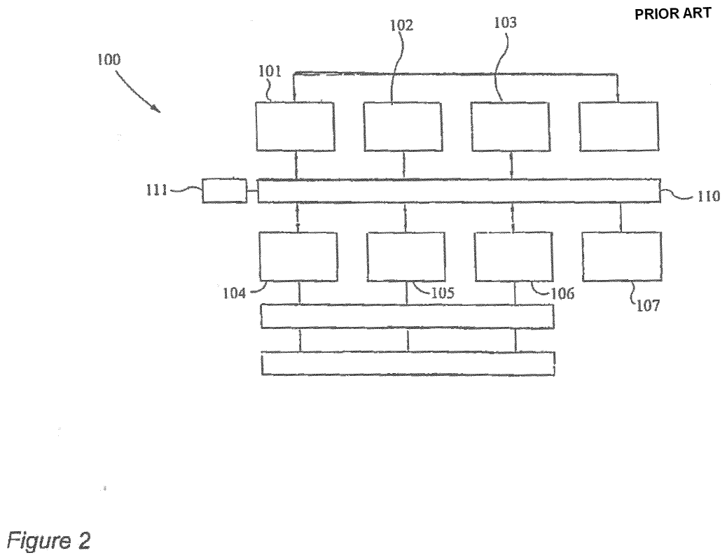

FIG. 2 illustrates another known computer system arrangement 100 for integrating subsystems 101-107 by using an integration bus 110 to facilitate the communication between the different subsystems. A server 111 is connected to the bus 110. Extensive integration is still required to adapt the data between each origin and destination system. Even though the integration bus simplifies the physical communication between subsystems, including some basic data mapping and translations, it still effectively performs the task of adapting the data between each combination if source and destination system. Each subsystem also need to know things about the system on the other side and need to include adaptations to each other subsystem it needs to communicate with. The integration bus concept illustrated in FIG. 2 does therefore not reduce the number of integration cases that need to be actively developed, tested, and maintained even though it makes the process a bit simpler.

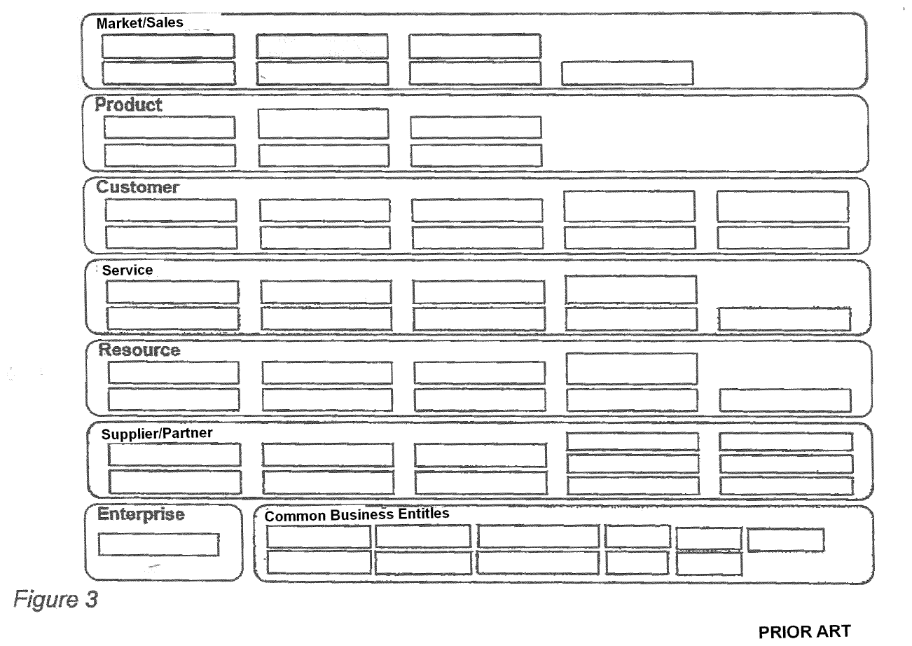

FIG. 3 illustrates yet another known computer system arrangement for an information model. It is furthermore known that adherence to such a common information model can simplify exchange of data between subsystems because it minimizes the need for complex translations between different information models. However, it does not reduce the number of integration cases even if adhered thereto, it just simplifies each integration. Each entity is thereafter broken down into a more detailed information model not shown here.

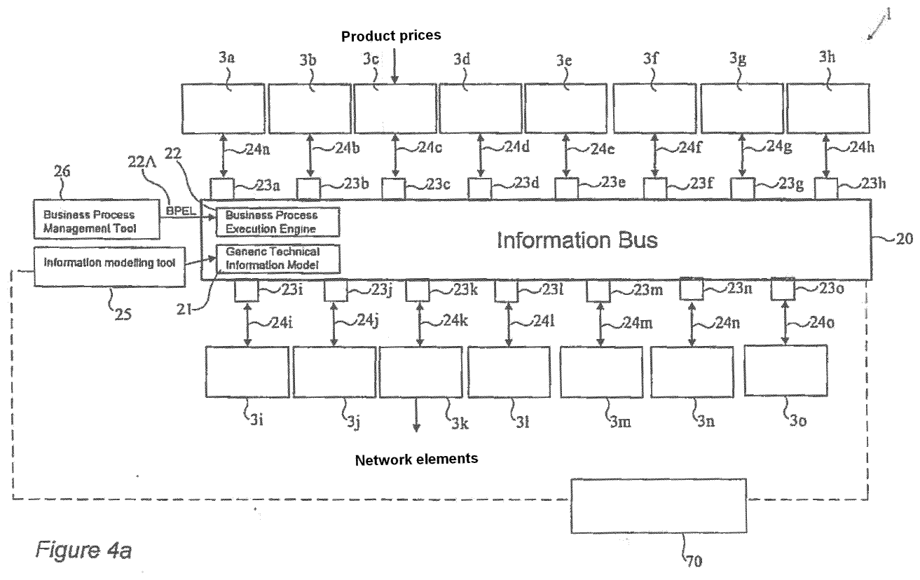

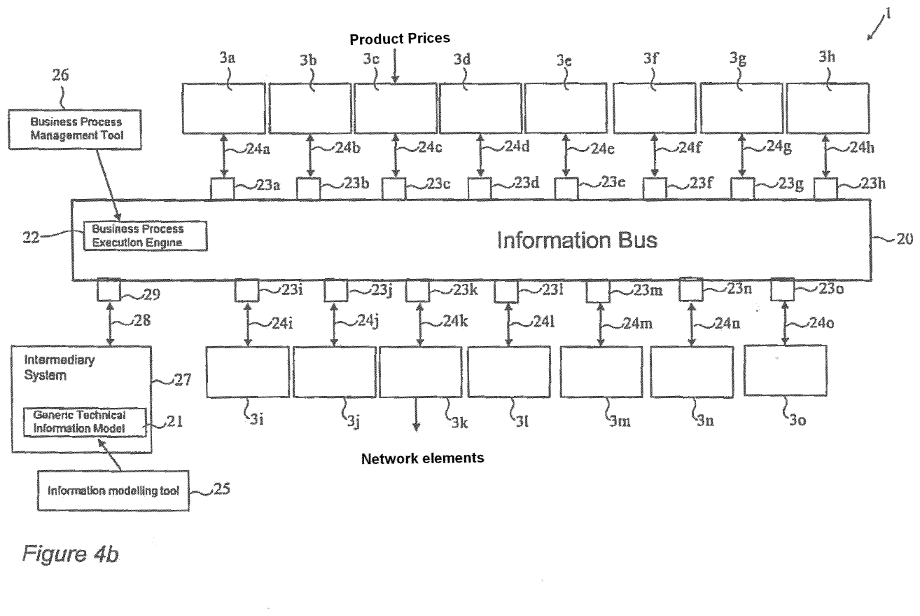

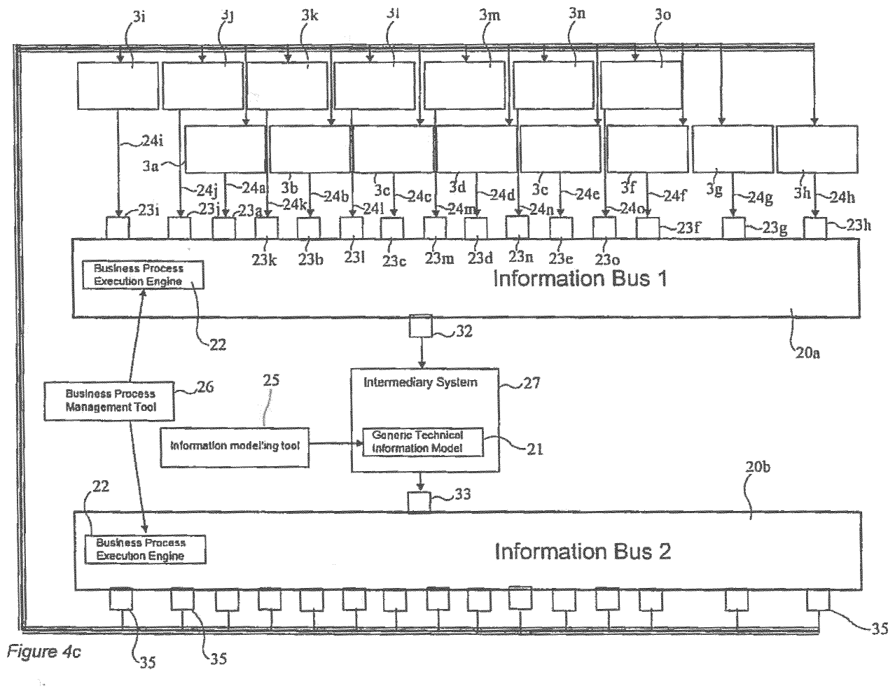

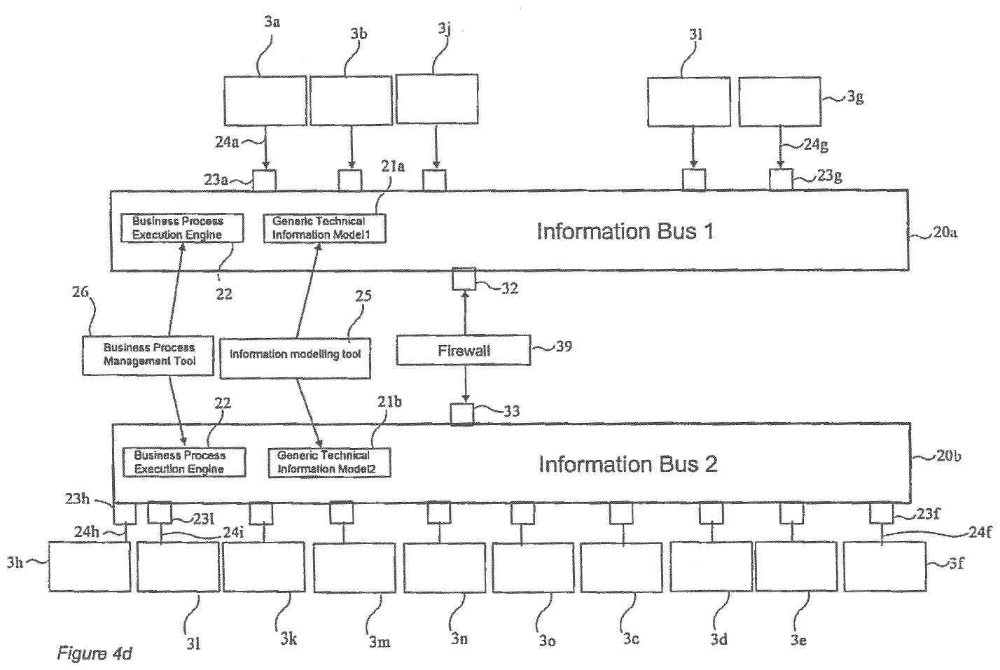

In FIGS. 4a-d , 5, 6, 7, 10, 11, and 12a the subsystems are denoted as follows: 3a denotes “CRM, Self Service and IVR”, 3b “Web Shop”, 3c “Product Database”, 3d “Accounting System”, 3e “Number Database”, 3f “Revenue Assurance”, 3g “Credit Card”, 3h “Customer Database”, 3i “Billing System”, 3j “Logistics”, 3k “Provisioning System”, 3l “Credit Control”, 3m “Trouble Ticketing”, 3n “Inventory”, and 3o denotes “Operations Support”. Furthermore, 3p denotes “Credit Card company”, 3q “Bank”, 3r “Pre-paid Account”, 3s “Top Up Function”, 3t “Reseller Web”, 3u “My pages”, 3v “Product configurator”, 3x “Invoicing”, 3y “G/L (Navision)”, and 3z denotes “Stock (Navision)”. Throughout all drawings, the adapters and connections, 23 and 24, respectively, are each denoted with the same index letter as the corresponding subsystem 3.

FIG. 4a illustrates a first embodiment of a computer system arrangement according to certain aspects of the technology disclosed, using an information model as an inherent part of the bus 20, and as an example using BPEL 22A (Business Process Execution Language) for the process execution and programming of the BPEE 22 (Business Process Execution Engine). Each subsystem 3a-o may have many external connections not passing through the bus (only a few examples are indicated in FIG. 4a). The data mapping is performed in each adapter 23a-o. This is the version mainly described in the text of this application as an example of implementation. Of course, the number of boxes 23a-o can be varied in accordance to the implementation as such.

In embodiments, the computer system arrangement according to the technology disclosed comprises a bus arrangement 20 having connections 24a-o to each one of the at least three applications 3a-o. The bus 20 is arranged to interpret between each of the at least three application 3a-o and to orchestrate incoming and outgoing requests from each application 3a-o. The bus arrangement 20 includes: a generic information model 21 defining a set of generic parameters 61 in relation to the application parameters 70a, 70b of each application 3a-o, at least three adapters 23a-o arranged to interconnect each connection 24a-o with the generic information model, the at least three adapter 23a-o together with the generic information model 21, in connection with an incoming request, being arranged to map parameters of that individual data model 70a to the generic parameters 61, and means arranged to transfer the mapped generic information model 6 together with the request to a process execution engine 22. Furthermore, the process execution engine 22 includes means arranged to handle the request to identify a corresponding adapter 23a-o to which the request was directed, and uses the corresponding adapter 23a-o together with the generic information model 21 to remap the request to the individual data model 7b of the application 3a-o to which it is was directed. The applications, the adapter and the connections in between are in all figures generally denoted with the reference numbers 3, 23 and 24, respectively, but can also be marked with an index to show their mutual association or with a specific reference number.

In embodiments, the computer system arrangement according to the technology disclosed comprises a bus arrangement 20 having connections 24a-o to each one of the at least three applications 3a-o. The bus 20 is arranged to interpret between each application 3a-o and to orchestrate incoming and outgoing requests from each application 3a-o. The bus arrangement 20 includes: a generic information model 21 defining a set of generic parameters 61 in relation to the application parameters 70a, 70b of each application 3a-o, adapter 23a-o arranged to interconnect each connection 24a-o with the generic information model, the adapter 23a-o together with the generic information model 21, in connection with an incoming request, being arranged to map parameters of that individual data model 70a to the generic parameters 61, and means arranged to transfer the mapped generic information model 6 together with the request to a process execution engine 22. Furthermore, the process execution engine 22 includes means arranged to handle the request to identify a corresponding adapter 23a-o to which the request was directed, and uses the corresponding adapter 23a-o together with the generic information model 21to remap the request to the individual data model 7b of the application 3a-o to which it is was directed. The applications, the adapter and the connections in between are in all figures generally denoted with the reference numbers 3, 23 and 24, respectively, but can also be marked with an index to show their mutual association or with a specific reference number.

Furthermore, FIG. 4a presents an advantages embodiment wherein there is main use of bus and process monitor 70, which may be used to monitor this state of the bus. For instance, it's possible to view where requests may queue up, errors may occur, timeouts may occur, delays may occur and other performance statistics. In this way it will be possible to identify possible problems, e.g. delays, to identify suitable actions (e.g. increase some bandwidth, computer performance, etc.) and to check how each system is performing. This information can be correlated with a business process defined in the business process management tool 26 in order to correlate the performance with each business process. Accordingly, it facilitates to identify what processes are affected by a certain problem. The other way around, if there is an observed performance problem with a certain process, tool 70 can help to identify what adapters/applications the problem seems to occur. Further, it can be used to drive business related information such as increased customer activity, churn, etc. that can accumulate activity from several applications.

FIG. 4b illustrates a second embodiment of a computer system arrangement according to the technology disclosed, where the generic information model 21 is used in a separate system 27 through which all information will pass and be remodelled. In this case, the information bus 20 itself is a conventional implementation, but used in a new context since it adapts the information to the connected subsystems 3a-3o, by means of using a specific adapter 29, having a connection 28 to a separate, external subsystem 27 including the GTIM 21 (Generic Technical Information Model) performing the translation to/from the technical information model and communicating with the BPEE 22, within the bus 20. The subsystem 3i is a billing system including invoicing, CDR collection, etc. It should be noted, that the information passes the subsystem 27 twice, viz. the first time on the way in from the source before the business process takes over, and the second time on the way out to the target after the business process.

FIG. 4c shows a third embodiment of a computer system arrangement according to the technology disclosed in which two different integration buses 20a, 20b, by means of one adapter each 32 and 33, respectively, are used to operate with one common external subsystem 27 that contains the technical information model 21. The buses 20a, 20b are connected to each application 3a-o for outputs and inputs, respectively. Hence, each subsystem 3a-o is connected to one bus 20a to send information for translation/execution, via adapters 23a-o and to the other bus 20b, via corresponding adapters 35 and/or adapters 32 and 33, to receive processed information.

FIG. 4d shows a fourth embodiment of a computer system arrangement according to the technology disclosed with two buses 20a, 20b, wherein a firewall 39 is used to separate more public systems from more internal systems with higher access security.

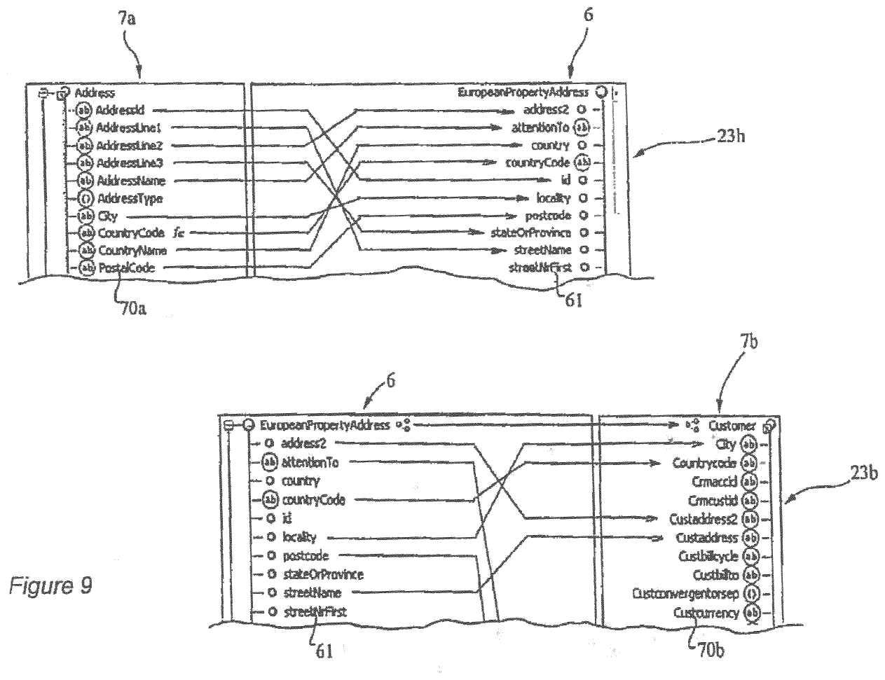

The solution shown in FIG. 4a combines the solutions described above such that the bus 20 itself has its own information models (standard or proprietary) and that all information translations goes through the bus 20, basically translating it twice; once from the origin system 7a (see FIG. 9) to the bus information model 6, via an “incoming” adapter 23, and once to the target system information model 7b, via an outgoing adapter 23. This includes any required protocol and format conversions (the classic role of an information bus), but may also include combining information from a variety of sources and subsystems, which provides further advantages.

In principle, this can reduce the number of integrations from about n(n−1) to about 2n. This is different from existing solutions with integration hubs or similar in that it strictly uses the information model in the bus such that an origin system does not have to be aware of changes in formats, protocols or concepts used in the target system or if subsystems are divided or merged. Therefore, one subsystem can, for instance, replace another without affecting all the other subsystems after just integrating it with the information bus and making necessary translations to the information model in the bus.

As a comparison, participants in a meeting of representatives with n different native languages need n(n−1)/2 interpreters if each interpreter only can translate between two languages (i.e. in both directions). If the number of languages gets large, the number of interpreters rapidly explodes. With 10 languages represented, 45 interpreters are needed. With 100 languages 4950 interpreters are required—at a cost and logistic complexity far beyond their value. However, if all interpreters can translate to/from English (or some other common information model), only n interpreters are needed, in this case 10 (or 9 if one native language is English) instead of 45. If 100 languages are represented, 100 interpreters are needed instead of 4950, etc. This illustrates the difference in integration complexity between known technology and the computer system arrangement according to the technology disclosed. To use a shared data model, which is also a known technology, corresponds to everybody using English.

As an alternative to have the information model 21 in the bus 20 as in FIG. 4a, it can be placed in an external unit 27 to the bus 20 as in FIG. 4b, thus a kind of system that all information passes through on its way from an origin to a destination system. In this case, there is no information model unit 21 in the bus 20 itself. Rather, conversions are made to/from the information model 6 (see FIG. 9) in the external system 27. The advantages and principles would in this case be the same except that the bus itself does not need the capability to include an information model unit 21. Instead, the information model unit 21 is implemented in the external module 27. However, which alternative is preferable depends on the implementation. Two alternative principles are shown in FIGS. 4b and 4c.

In a similar way as the information model 6 (see FIG. 9) is handled, all processes are defined in a process management and design tool 25. The processes are then run through integration with, for instance, the BPE engine 22 that is connected to the bus 20 via connection using BPEL 22A. See FIG. 4a.

The information model may be described as consisting of two different but corresponding models, one used in the organization which is mapped to the one implemented inside the information bus 20.

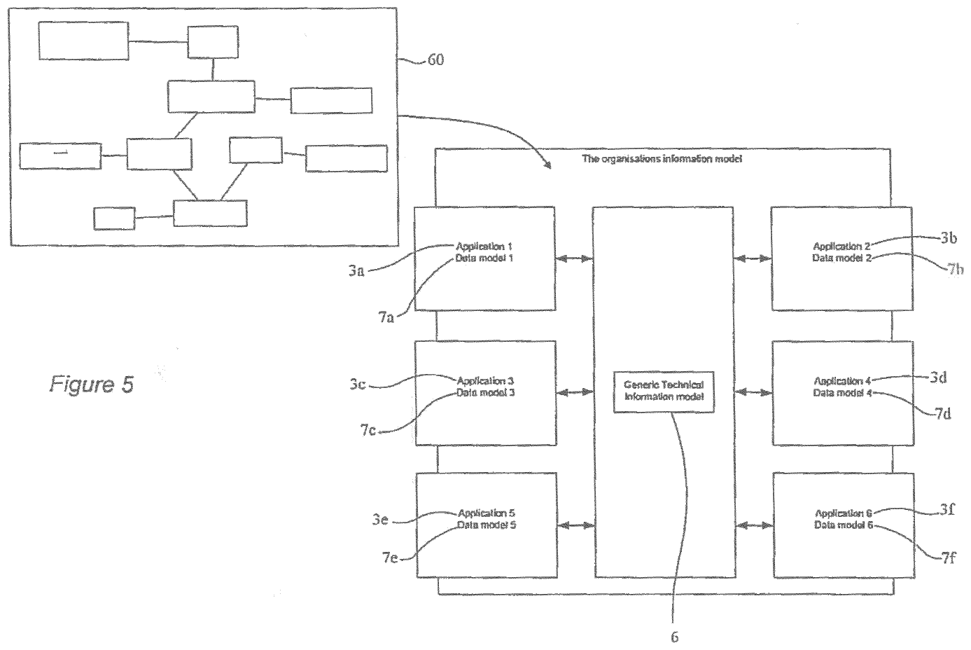

FIG. 5 schematically illustrates the relationships between information models in the bus 20, in the applications 3a-3f and in the organization. The organization information model (OIM) 60 defines the concepts and their relationship that the organization is using, e.g. a Customer is called a “Customer”. These concepts are used in the organizations day to day life. The Generic Technical Information model 6(GTIM) defines the concepts and their relationship on an accurate and technical level. The OIM 60 is mapped to the GTIM 6 as well. In the preferred mode it is possible to use externally defined models like the TM Forum SID model, as it is or modified. Each connected application 3a-f has a data model 7a-f (ADM) defining the concepts and relationships within that application. Each ADM 7a-f is mapped to the GTIM 6 used within the iBus 20, so that data transformations may be done in each adapter 23. The ADM:s 7a-f are therefore also mapped to the OIM in a manner.

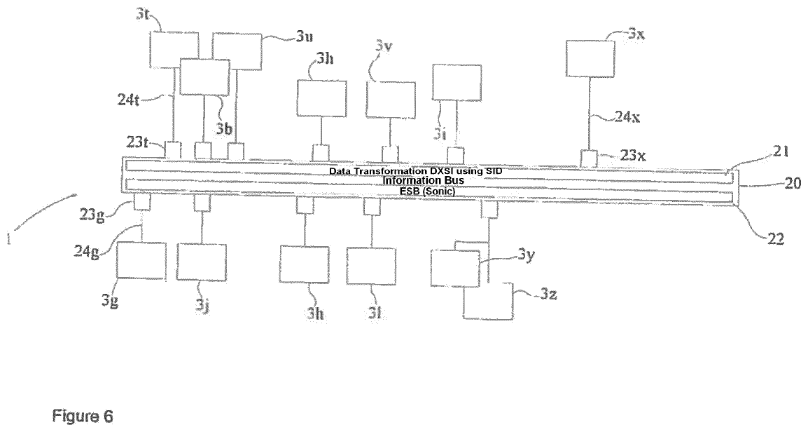

FIG. 6 illustrates a fifth embodiment of a computer system arrangement 1 according to the technology disclosed. By means of this embodiment a typical implementation of the computer system arrangement is illustrated using known components available on the market, e.g. using Data transformation unit 21 based on DXSI using SID, and an Execution engine 22 in the form of ESB (Sonic). Other known systems of this kind may be used.

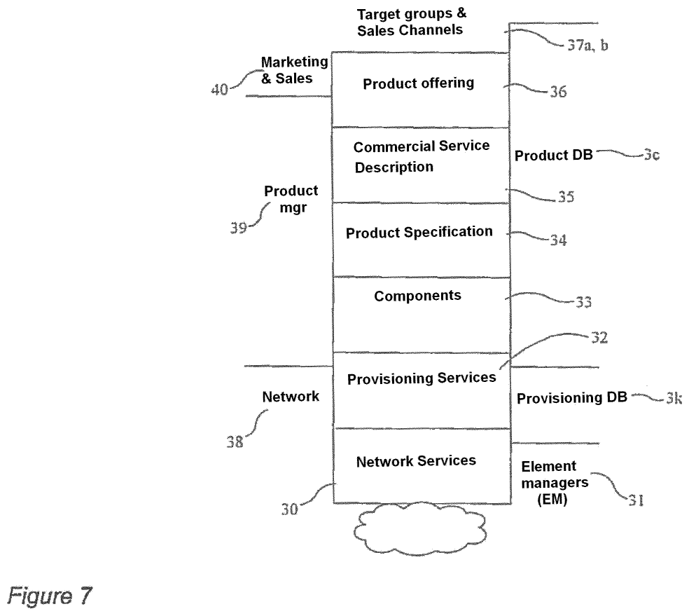

FIG. 7 illustrate how for instance a product definition is built up and how it relates to different parts of the organization and different subsystems, e.g. 3c and 3k of the system in FIG. 4a. It, for instance, illustrates the role of a product database 3c in a possible solution. When looking from bottom up, in this example the products base, is the Network Services 30, the services that exists in the network. They are managed by Element Manager Applications 31. Sometimes several of these Network Services 30 needs to be combined in order for setting up the functionality in the network, which is done by using the Provisioning Service 32, which is mastered and managed by the Provisioning DB 3k. This also enables to isolate the Element Managers 31 from the higher levels of the product hierarchy, so these definitions become independent from the different vendors of Element Managers 31. The upper level of the hierarchy is managed by the Product DB 3c. In order handle the complex products sold, they are structured in two main layers, the technical definition layer (Components Specification 33 containing Services, Resources and Technical Attributes, and Product Specification 34 containing Technical products and Technical rules) and commercial definition layer (Commercial Service Description 35 containing Commercial Products, Bundles, Pricing Plans and Discount rules, and Product Offerings 36 containing Special Offers, Commercial rules and Standard Offers). A product specification is made up of one or more components and knows the rules on how these can be combined and utilized. A Commercial Service Description 35 adds commercial rules, price plans, discount plans etc and can only use what is defined on the Product Specification 34 level. The Commercial Service Description 35 cannot be sold to a customer, only a Product Offering 36 can be sold. Many Product Offerings 36 can be defined from a Commercial Service Description 35. The Product Offering 36 also knows through which Sales Channels 37a it can be sold as well as which Target Groups 37b that are targeted. All levels in the hierarchy are version handled and may also have lifecycle information, like maturity state, validity dates, etc. To the left you can see the proposed responsibility for each layer, where the Network Department 38 might be responsible for the Network Services 30 and the Provisioning Services 32, the Product Management 39 for the Technical and Commercial Layers, but where Marketing and Sales 40 are responsible for the part of the Product Offering 36 that the customer will see and receive.

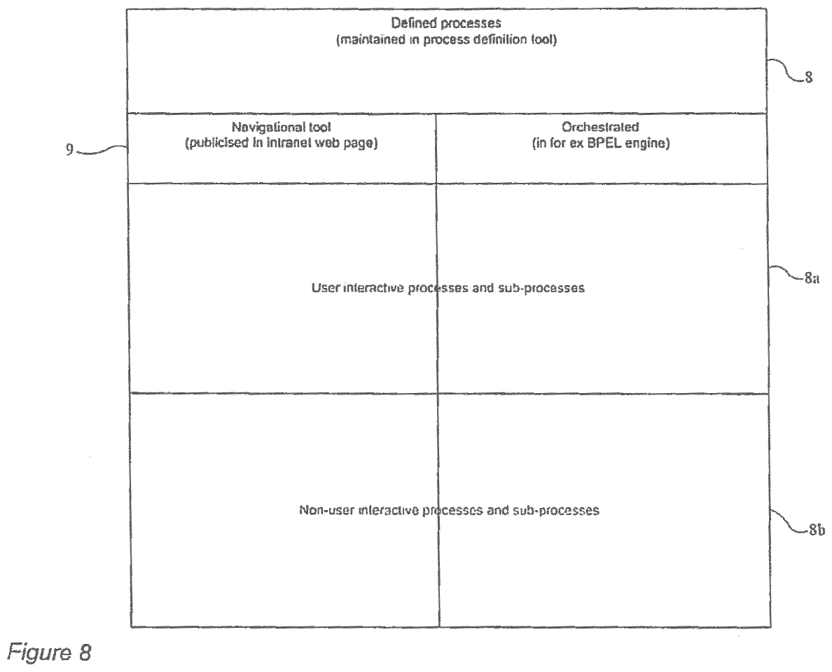

FIG. 8 illustrates process relationships. All the defined processes 8 are handled in a process management tool 26 (see e.g. FIG. 4a). This tool 26 produces process schemas 8a, 8b that can be visible and navigated, on a navigation tool 9, e.g. on an internal WEB-page as a kind of guidelines to the organization. The tool 25 is also used to produce BPEL or other intelligent code to be utilized in the iBus 20 by for ex a BPEL engine 22. This relationship is two ways. The processes are orchestrated differently depending on if they are user interactive processes 8a or non-user interactive processes 8b. Thanks to coordinating both kinds of processes by means of the same tool 26 it is possible to achieve system integration with a high degree of control/accuracy in a complex structure, and to perform changes within the system in a flexible and well controlled manner, safeguarding cost-efficient and reliable operation of the system.

FIG. 9 is an example of data mapping or data translation between an application 3 connected to the bus 20 and the Generic information model 6 (GIM, preferably a CRM system) used in the GTIM 21 in the bus 20, according to certain aspects of the technology disclosed. For example, it is shown that in a first adapter 23h the address field 61 is mapped from a first ADM 7a (e.g. used within a Costumer Database 3h), over to the GDM 6 and via a second adapter 23b, from the GDM 6 to a second ADM 7b (e.g. used within a webshop 3b).

The computer system arrangement according to the technology disclosed is adapted for minimizing communication and integration complexity between a plurality of software applications, wherein at least a subset of these applications 3a-o (see e.g. FIG. 4a) has an individual data model (ADM) 7a-o, each defining an individual set of application parameters 70a-o, and wherein a first mapping within a first adapter 23 may first be achieved from an ADM 7a belonging to an incoming request 70a to the bus 20, whereby the GTIM 21 translates it 70a into a standard object/parameter 61 using the GIM 6. Subsequently, by means of the BPEE 22 the translated object/parameter is directed to one (or more), i.e. at least to a second, adapter 23, wherein the translated request 61 is remapped into an object/parameter 70b according to the ADM 7b of the application 3 to which the incoming object/parameter 70a was intended.

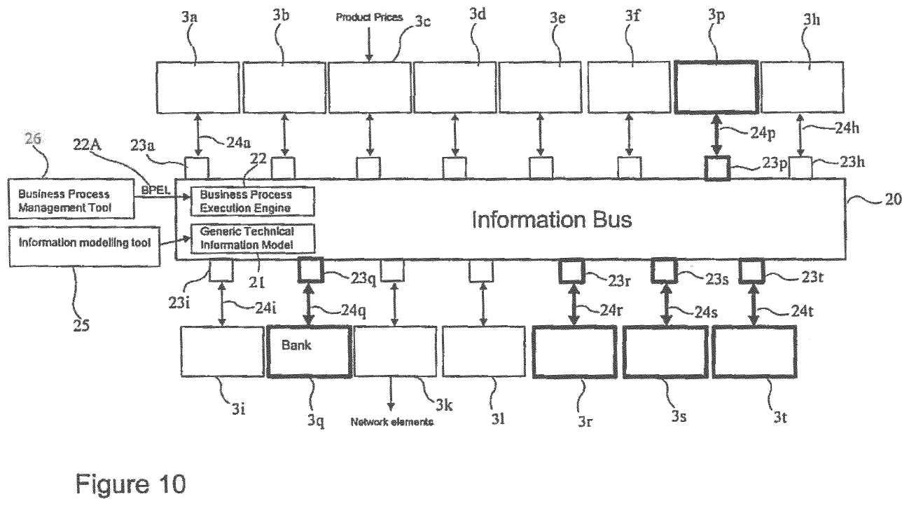

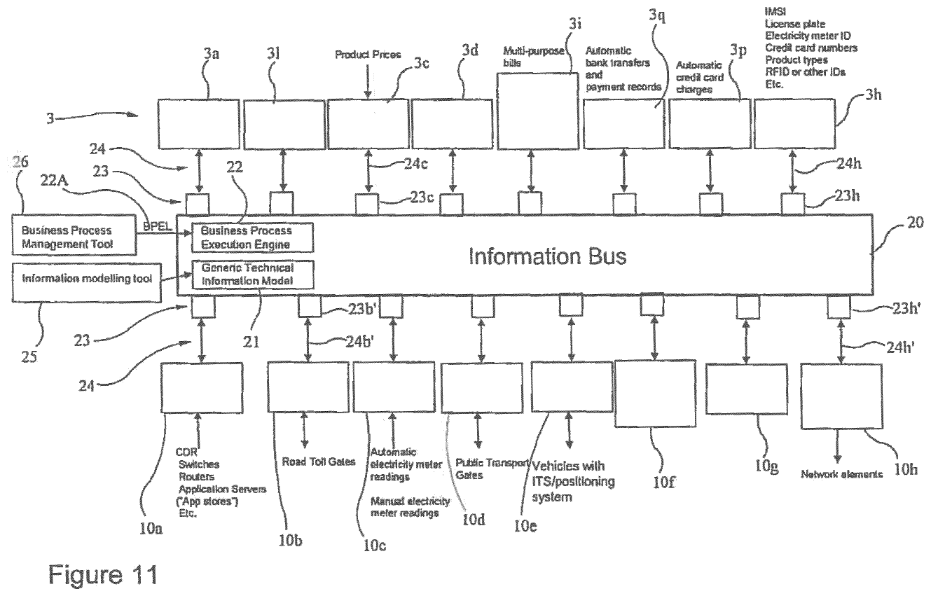

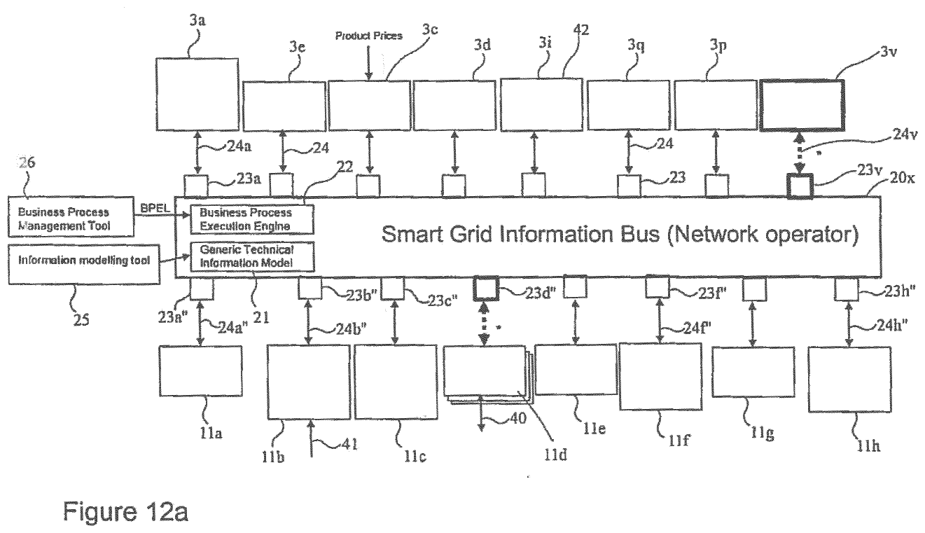

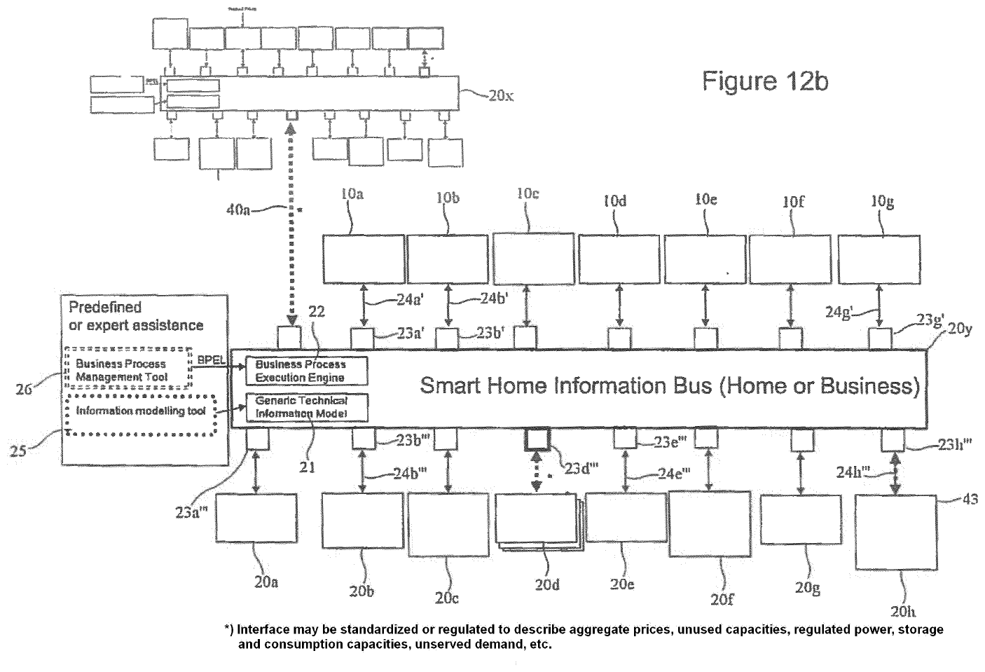

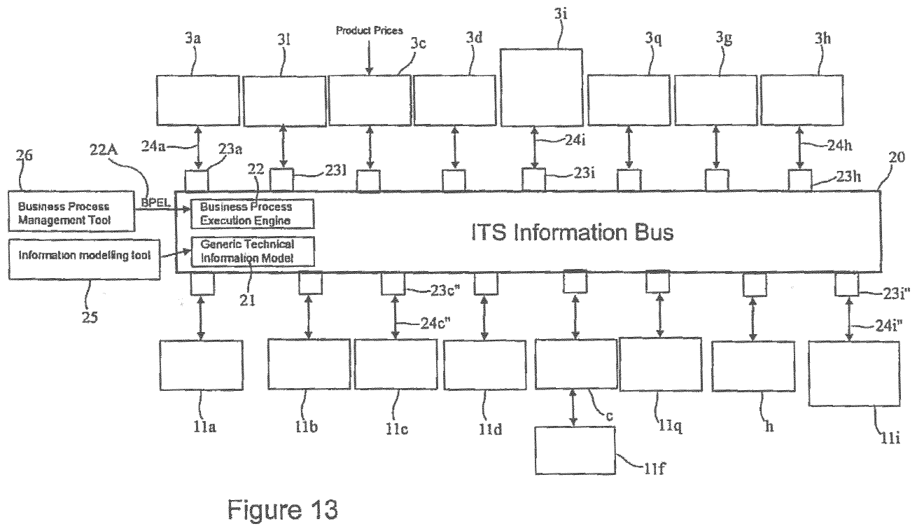

As is evident for the skilled person, the technology disclosed can be used and adapted for slightly different applications. Five examples are given below:
1. Handling of pre-payment and real-time billing and credit checking. Cellular operators or utilities sometimes apply post-payment, i.e. bills are issued after collecting data records and calculating the amount due. In conjunction with the initiation of the subscription, this is normally combined with some assessment of credit-worthiness. This is handled by the technology disclosed as described earlier by having access to a credit assessment function (e.g. access to a system that determines credit-worthiness based on certain parameters). However, the technology disclosed can also be used for integrating a pre-payment system, where one of the subsystems keeps track of each users account status with functions to credit, debit, and check an account. See illustration in FIG. 10.
2. Handling of micro-payment and transformation of single-purpose to multi-purpose payment systems. The technology disclosed allows using e.g. a cellular operator's billing, pre-payment credit/debit functions etc. for other purposes than to charge for telephone calls (or an energy company's system to charge for electricity to also charge for other things). One example shown in FIG. 11 is to connect e.g. toll gates, vending machines, and other micro-payments to a mobile phone subscription. This can be done also without using the technology disclosed, but the technology disclosed makes it much easier to integrate the systems and use solutions already developed for different purposes dramatically reducing the development cost and time to take advantage of the combination effect.
3. Smart Energy Grid. Modern solutions to optimize the production, storage, transmission and consumption of electric energy are often referred to as “Smart Grid”. These solutions are dependent on communication and integration between a large number of devices and systems with different origin and function to work efficiently. In fact, this is one of the main barriers for wide-scale deployment of such solutions. Communication can be solved using e.g. a national wireless network with good coverage in e.g. the 450 MHz band. The technology disclosed is ideal to simplify also the implementation of Smart Grids as illustrated in FIG. 12.
4. Intelligent Traffic System (ITS). The invention does not require stationary systems. On the contrary, stationary subsystems can be combined with mobile systems, for instance vehicles with some sort of identity and properties. FIG. 13 illustrates one example of an Intelligent Traffic System, where the computer system arrangement according to the technology disclosed is used to integrate the different systems by using a bus with a generic information model 5. Business Support Systems (BSS) and Operations Support Systems (OSS) in connection with Internet of Things (IoT) and Cloud-based solutions. Business support systems (BSS) are the components that a telecommunications service provider (or telco) uses to run its business operations towards customers. Together with operations support systems (OSS), they are used to support various end-to-end telecommunication services (e.g., telephone services). BSS and OSS have their own data and service responsibilities. The two systems together are often abbreviated OSS/BSS, BSS/OSS or simply B/OSS. BSS deals with the taking of orders, payment issues, revenues, etc. It supports four processes: product management, order management, revenue management and customer management. Product management supports product development, the sales and management of products, offers and bundles to businesses and mass-market customers. Product management regularly includes offering cross-product discounts, appropriate pricing and managing how products relate to one another. Service providers require a single view of the customer and regularly need to support complex hierarchies across customer-facing applications (customer relationship management). Customer management also covers requirements for partner management and 24x7 web-based customer self-service. Customer management can also be thought of as full-fledged customer relationship management systems implemented to help customer care agents handle the customers in a better and more informed manner. Revenue management focuses on billing, charging and settlement. It can handle any combination of OSS services, products and offers. BSS revenue management supports OSS order provisioning and often partner settlement. Billing is an integral function offered by BSS systems and is not under the purview of OSS. Order management encompasses four areas: Order decomposition details the rules for decomposing a Sales Order into multiple work orders or service orders. Order orchestration is an objective application which is used by telcos to precisely manage, process and handle their customer orders across a multiple fulfillment and order capture network. Order fallout, also known as Order Failure, refers to the condition when an order fails during processing. Order status management. Order management as a beginning of assurance is normally associated with OSS, although BSS is often the business driver for fulfillment management and order provisioning.

FIG. 10 illustrates a certain embodiment where the technology disclosed is applied for handling pre-payment and real-time billing and credit checking. It can be noted that interfaces/integrations to credit card companies 3p, banks 3q, etc. can be re-used and shared by the post-paid and pre-paid systems showing another advantage of the technology disclosed when integrations can be used for new purposes (like using a debit function for the credit card company developed for post-paid to also work for pre-paid automatic top-up. The highlighted applications 3p, 3q, 3r, 3s, 3t with corresponding adapters 23p-t are the key systems involved in the handling of prepaid transactions.

FIG. 11 illustrates a certain embodiment where the technology disclosed is applied for handling of micro-payments for a variety of purposes, in this example gaming, application download, public transport, toll gates, ITS and vending machines. Moreover, 10a denotes “Telecom mediation”, 10b “Toll gate reader”, 10c “Electricity metering”, 10d “Subway gate reader”, 10e “Dynamic road toll System”, 10f “App. And Media Store”, 10g “Vending Machines”, and 10h denotes “Cellular Provisioning System”.

FIG. 12a illustrates a certain embodiment where the technology disclosed is applied in a Smart Energy Grid to connect a variety of units and systems with different functions. In this illustration, the technology disclosed is used (independently) both by the Power company and in the Home smart meter implementation, with an interface that fully or partly may be standardized or nationally regulated to encourage the development of the smart grids. Each unit in the lower part of the illustration has permanent data and variable data such as topological information about physical connections, capacity, un-utilized capacity, type of device (generating, storing, transmission or consuming), forecasted load or production (e.g. when charging of an electric car has to be completed), price thresholds to increase/decrease production, consumption, storage, etc. Here, Ila denotes “Topology database”, 11b “Optimization, forecasting and trading system”, 11c “Distribution Network Control/Monitoring”, 11d “Smart Metering (aggregator)”, 11e “Power Plant”, 11f “Storage facility”, 11g “Electric Vehicles”, and 11h denotes “Home of Industry Appliance”. The Smart meter 40/11d may have certain functions to autonomously buy and sell electric energy power, to control non-time critical consumer items in the home or industry (like electric water heaters, air conditioners), etc. depending on the price and user settings. Likewise, the power company can build a system 41/11b to optimize and plan its production based on its knowledge about how much consumption can be increased/decreased, cost and capacity for electricity transmission, etc. It could also mean that a wind power or solar power company can make a deal with battery bank owners/electric car owners to store energy in their batteries with certain terms of use. Central accounting and billing functions 42 determine the electricity bills based on data collected from the meters, etc. The operations central of the power company can see any deviations in consumption etc. by matching data from different parts of the network. A home owner can see details not available to the power companies and can set rules for what devices that should go on under what price conditions, or override these settings when necessary. The generic data model in the information bus need to be able to describe all data that needs to be exchanged between the different units, but the bus associated with a smart meter/smart home, does not have to have the same data model as the power company's bus. Different power companies work with different kinds of smart grids and policies for optimization. It may be useful with standardized interfaces between different power companies 3v and interface 40a (see also FIG. 12b) between each customer premise and the power company that contain mandatory and optional information, private and public information (only accessible to authorized users). The information in these interfaces would typically refer to aggregate steerable capacities, etc., current electricity cost for user to decide to e.g. start a device, override normal settings, consumption information (meter reading data), etc. The system is very suitable for stepwise additions of increasingly advanced capabilities and new functions while parts of the network are still of “old” type.

FIG. 12b shows a similar architecture as the architecture illustrated FIG. 12a , but, in this certain embodiment, the Smart Metering device itself is made up of a home or small business bus, which in itself is a version of the technology disclosed, allowing control and optimization of a variety of electricity sources, storage, and consumption devices into a smart home implementation—without giving the energy company access to all private information—only aggregate data, but still allowing very advanced optimization of the home or business energy usage.

Other utilities such as water meter and security 43/20h may use the same type of smart home information bus shown in FIG. 12b. These utilities may then share many functions and communication channels. For instance, to raise alarm in case of abnormal temperatures or water flows. The user accesses the home installation using a control panel, or more likely by using a computer with a web browser to access a built-in web server.

FIG. 13 illustrates an Intelligent Traffic System (ITS), and an ITS Information Bus, based on certain aspects of the technology disclosed where some of the systems may be mobile, using a wireless radio communication system for the communication. In example embodiments, the intelligent traffic management system may apply a toll fee depending on the current or expected congestion and/or pollution level, combined with traditional toll gates, and functions to optimize traffic flow. Vehicles can then have built-in units that calculates (or requests) least-toll or speed optimized routes. At the same time, central functions can get better data to anticipate congestions. The technology disclosed according to certain aspects allows adding increasingly advanced functionality to legacy systems for e.g. toll road payments.

According to the method for creating a computer system arrangement in accordance with embodiments described above, the information model mapping between the individual application data models 7, the generic information model 6, and the information model 60 used in the organization is performed using an information modelling tool arranged to define and describe the models and how they shall interrelate to each other.

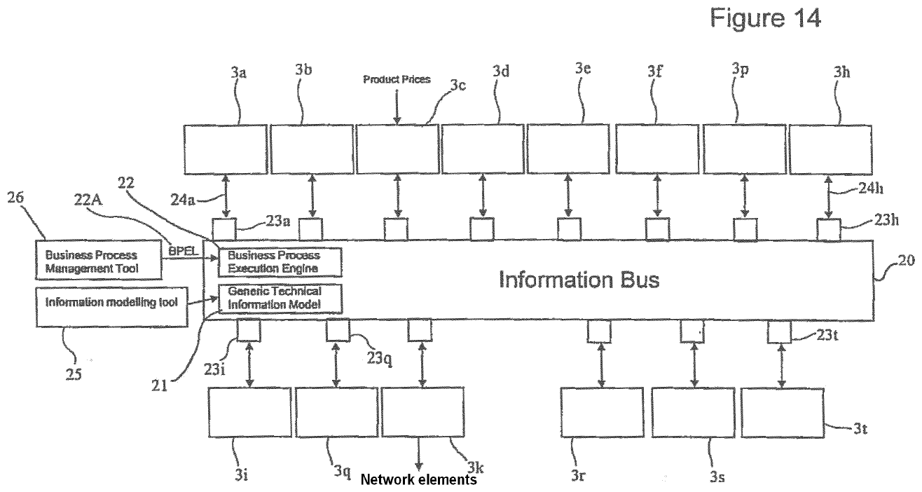

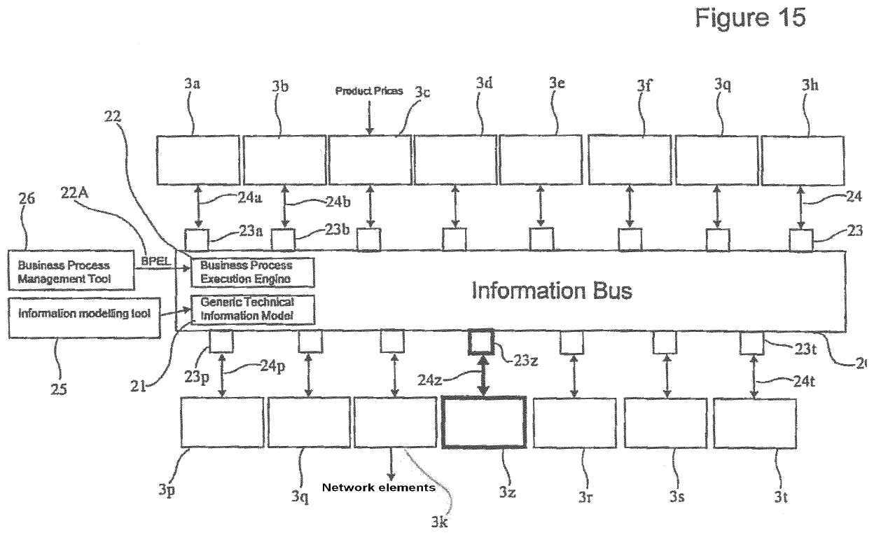

With reference to FIG. 14, there is presented an example of steps to add a function/application 3 to a computer system arrangement according to the technology disclosed, assuming the desire to add a credit check function to the system illustrated in FIG. 14to end up with a system as presented in FIG. 15. The reason to add the credit check application 3z could be that the operator suffers from, or fear to suffer from, some customers placing orders for post-paid products without the ability to pay for them. A condition for accepting such orders shall thus be that the customer is considered credit-worthy. Such credit-checking shall be accessible from several places, like the web shop, customer care, reseller web etc.

The following steps may be used to add the desired function:
1. Identify a suitable way to estimate the credit-worthiness of a customer. In this example, assume that a third-party company provides a credit check function/application 3z as a part of a credit-check system based on the customer's general credit history and other available information. An agreement is made with the company operating the credit check system which includes the agreed interface specification, e.g. as a Web Service.
2. Produce a physical connection and security specification (can be of any kind e.g. Web Service XML, api, structured file of any sort, etc).
3. Perform logical connection and information mapping i.e. data model mapping between the information structure in the credit check application 3 and the generic mode used in the GTiM 21 in the information Bus 20. This is then handled in the adapter 23z for the credit check. If the data model requires changes in the Generic Technical Information Model 21 in the Information Bus 20, this will be done in IMT 25 and then updated in the GTiM 21 in the Information Bus 20.
4. Use cases definition and process definition/modification. (The process involved are modified/created in the BPMT 26 and then updated in the BPEE 22 in the information Bus 20).
5. Fault handling definition and Quality Assurance specification. (The processes involved are modified/created in the BPMT 26 and then updated in the BPEE 22 in the information bus).
6. Testing, deployment and simulation. Testing is first made in a separate testing system, then deployment and simulation is performed in the production environment without disrupting the production.
7. When simulations are satisfactory, the modified process(es) that includes the credit check application 3z is activated by changing its status from simulation to production. The next next time the process is invoked, the credit check application will be performed without any interruption by calling the application 3z.
8. New use cases calling that new application 3z may be added later. For instance, if the credit check application 3z initially was only used for orders from the web shop 3b, also other systems, like the CRM system 3a, can also use the credit check function/application 3z for certain products simple by modifying processes, without making any changes in the bus-credit check interface adapter 23a.

The adapters 23a-o fulfill at least two purposes, viz., on one hand, to translate/map data (see FIG. 9), and on the other hand, to request the desired process/activity. Thereafter, the adapter translates in both directions the activity request and also provides for supplying the data that has been translated by means of the adapter.

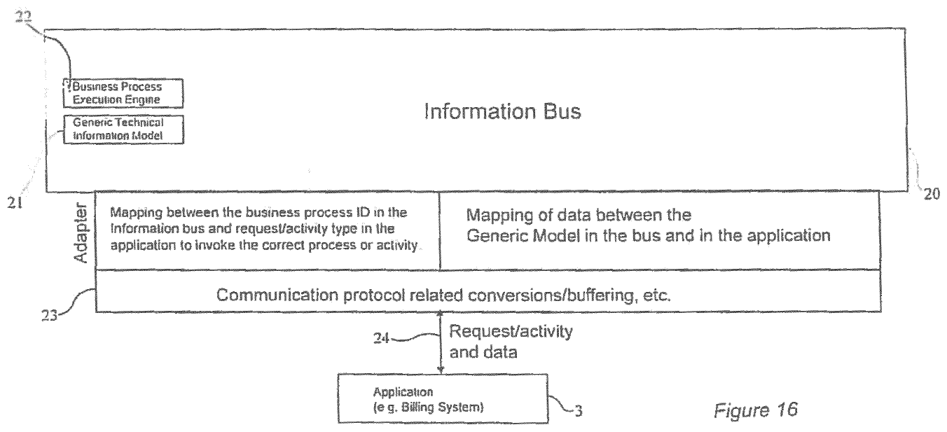

FIG. 16 schematically shows the functioning of the adapters 24 connected between the subsystems/applications and the information bus 20. The mapping of data is performed within each adapter 23.

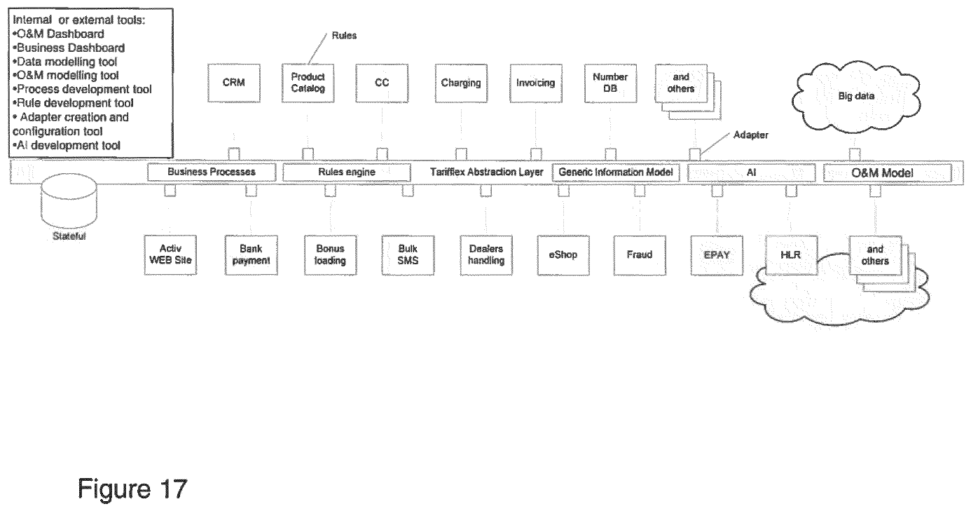

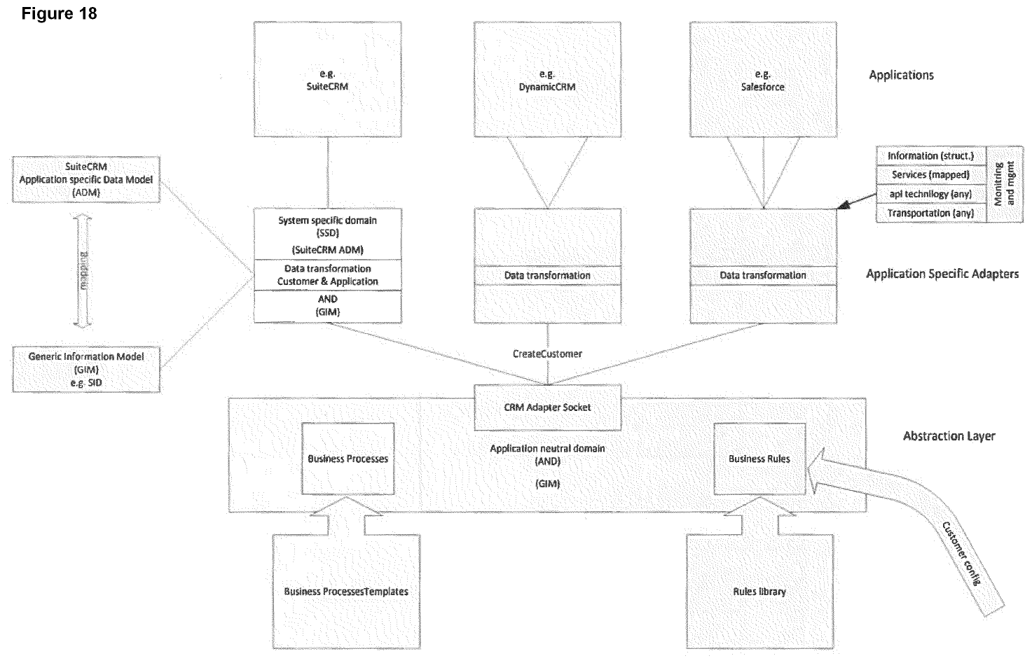

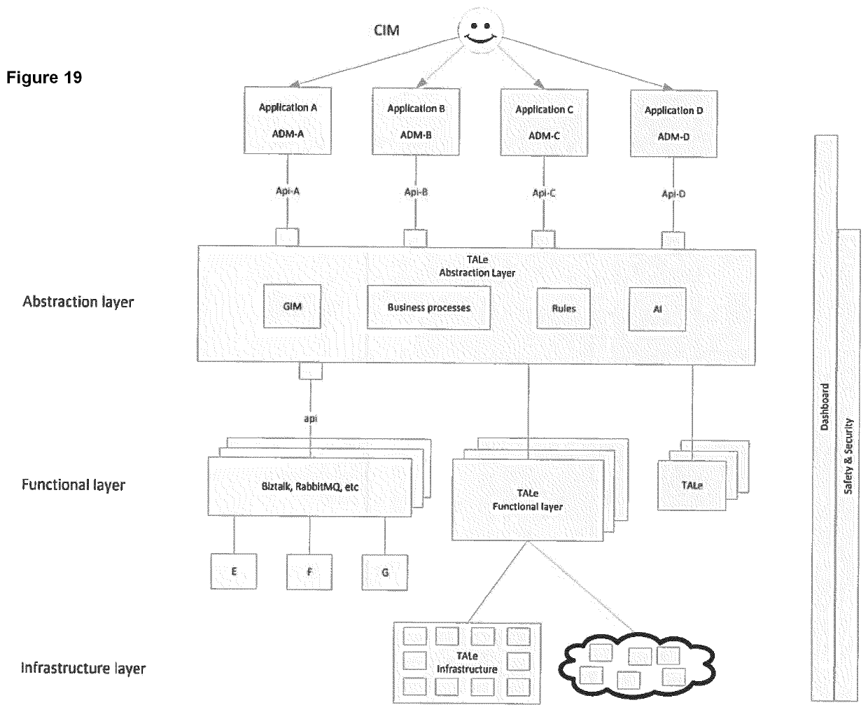

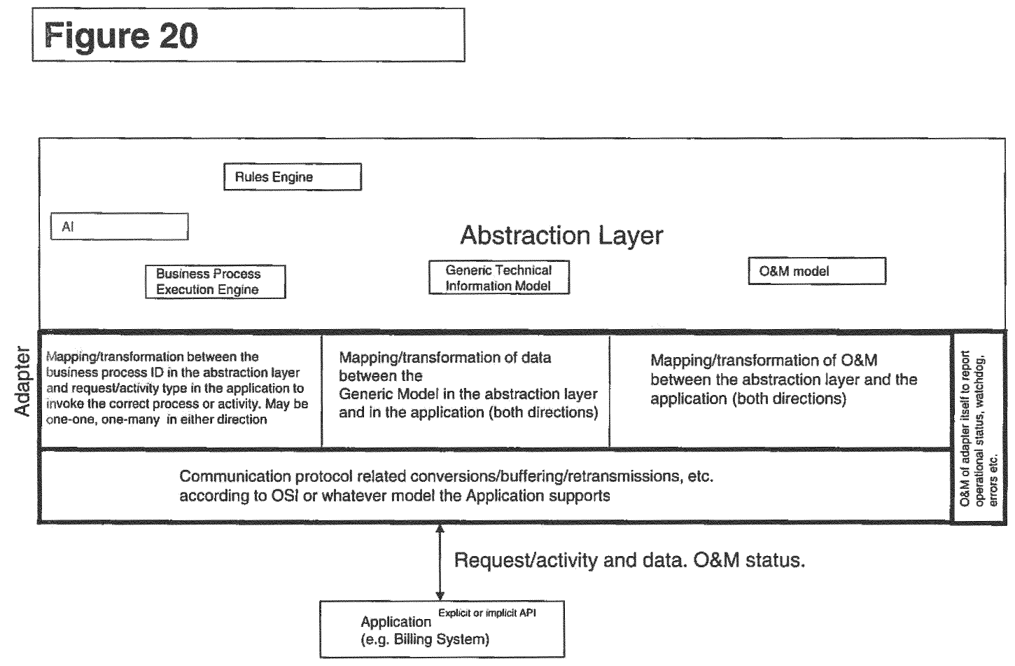

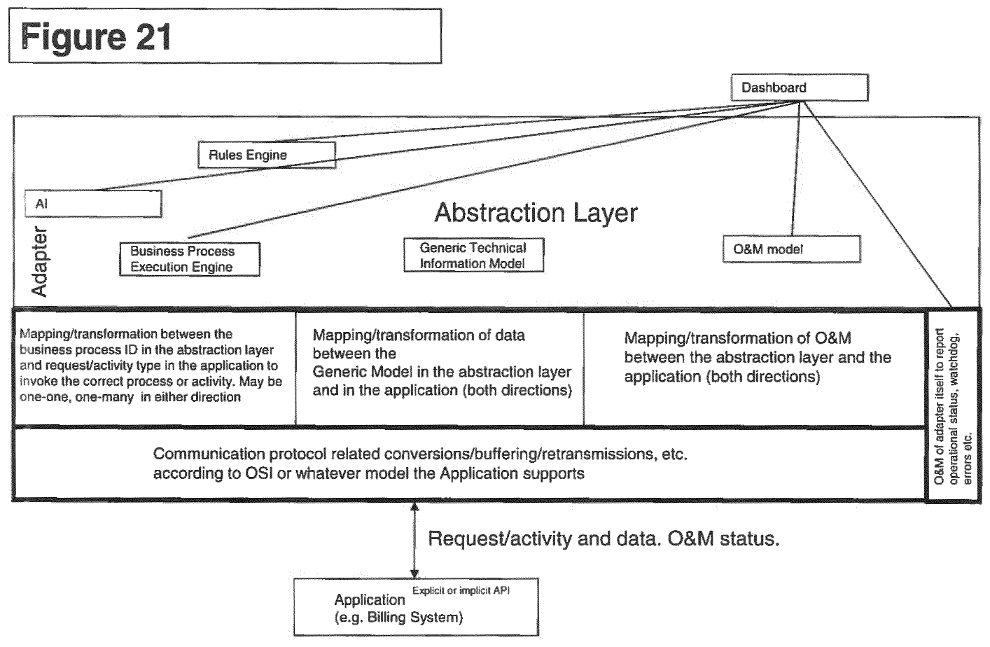

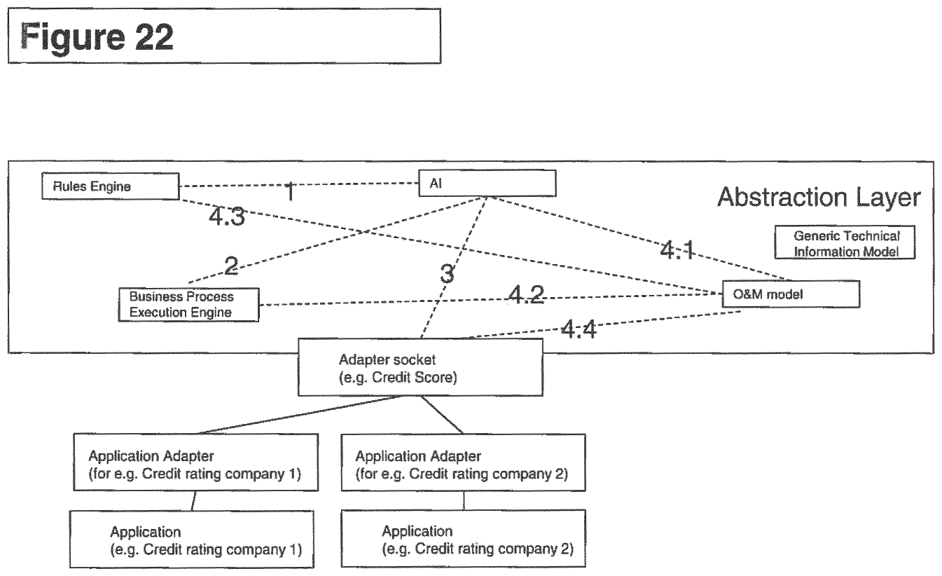

FIG. 17 illustrates an abstraction layer, or bus arrangement, according to an embodiment of the technology disclosed where the rule functions, defined in a Rules engine, “Rules engine” in FIG. 17, are separated from the (pure) business processes defined in a business process (execution) engine, “Business Processes” in FIG. 17. In example embodiments, at least three of adapters 23 of the abstraction layer, or bus arrangement, are configured to invoke a business process defined in the business process engine. The invoked business process may then be configured to invoke at least one of a plurality of rule functions defined in the Rules engine. The at least one rule function, which is then invoked from within the business process, then returns a value representing a business process branch among a plurality of business process options. In certain embodiments, the rule function may in addition be configured to return a value representing a stop or error.

Separating the business rules, or rule functions, defined in the Rules Engine, from the business processes defined in the business process engine, provides an improved ability to adjust business rules, or business rule parameters, without interfering with the business process flow. By separating the rule functions from the business processes, the amount of duplicated data and rules in the business processes defined in the business process engine may also be significantly reduced. This provides the further advantages that it is much easier to make changes to a business rule, or adjust a business rule parameter, and that the amount of integration and configuration needed to get the system operational after a change to a business rule, or business rule parameter, is lower. Thus, this embodiment of the technology disclosed illustrated in FIG. 17, where the business rules, or rule functions, are separated from the pure business processes in the abstraction layer, e.g. a bus arrangement, makes the process for making changes in the customer offering faster, less difficult and less costly. This embodiment of the technology disclosed also makes it less difficult to scale to large number of systems or to accommodate several operators needs in one system.

Rules may be of different types, legal and regulatory, company policies, product related (both commercial and technical).

The abstraction layer solution, or bus arrangement, directed to separating pure business processes from business rules according to example embodiments of the technology disclosed may include, but is not limited to, at least some of the following advantages over the prior art:
Fast and easy setup, excellent time to market
Easy to modify, to any need, at any situation
Flexible and modularized, can fit any need
Does not need duplication
Scales from small to large implementations
Suitable for implementation of consistent product configuration
Perfect for Artificial Intelligence (AI), machine learning and machine reasoning introduction

FIG. 17 illustrates an abstraction layer, or bus arrangement, according to an embodiment of the technology disclosed where the rule functions, defined in a Rules engine, “Business Rules” in FIG. 17, are separated from the business processes defined in a business process (execution) engine, “Business Processes” in FIG. 17. In this embodiment, the plurality of adapters of the abstraction layer, or bus arrangement, are configured to invoke a business process defined in the business process engine. The invoked business process may then be configured to invoke at least one of a plurality of rule functions defined in the Rules engine. The at least one rule function, which is then invoked from within the business process, then returns a value representing a business process branch among a plurality of business process options. In embodiments, the rule function may in addition be configured to-return a value representing a stop or error.

FIG. 18 shows the internal architecture and structure of the abstraction layer, or computer system, comprising three application adapters, “Application Specific Adapters” and an adapter socket, “CRM Adapter Socket”. The adapter socket, “CRM Adapter Socket” in FIG. 18, is a generic socket of the computer system, which is not depending on any specific supplier's system capabilities or definitions. The example embodiment illustrated in FIG. 18 shows three different CRM systems communicating through one and the same adapter socket. Above the adapter socket in FIG. 18, there are three different system related adapters, application adapters, one for each supplier (external systems and/or software applications 3a-o). The top part handles information and at least one Application Programming Interface (API) according to the application of the specific supplier, or external system/software application. Once a request is received, e.g. including a request for a service, certain application specific parameters and/or data, it is transformed to the application neutral (generic) information model and is also mapped to the generic process requested in the Application Neutral Domain (AND). There is a difference between processes in the System Specific Domain and the Application neutral domain in the adapter, as well as the Adapter Socket. There is also a difference between Business process inside the adapters and the processes mentioned in the adapters.

FIG. 19 illustrates an example embodiment of the structure and the role an abstraction layer may have. “CIM” on the top of FIG. 19, illustrates the person of the organization who is working with one or more of the applications, Application (A-D). The person has his view and the definition of the information handled according to CIM (Company Information Model). The applications may each have one Application Data Model (ADM), which is specific for each application. Each application communicates with the abstraction layer through the small boxes, the adapters (previously described e.g. in relation to FIG. 18). The Functional layer can be of different types, and in combination, e.g. Biztalk, RabbitMQ, etc or the TALe functional layer. It may be configured to communicate with other abstraction layers. On the Infrastructure layer, a Tale Functional layer can be implemented on a physical location, or in a cloud, or in a combination of these. The Dashboard (including management) function can act from and partially within the applications all the way to (and including) the infrastructure layer. Safety and security are handled from (and including) the adapters all the way to (and including) the infrastructure layer.

FIG. 20 illustrates the typical functions of an adapter 23 of the computer system 20, “Abstraction Layer” in FIG. 20. These example functions of an adapter include mapping, or data transformation, between the business process ID in the abstraction layer and request/activity type in the application to invoke the correct process or activity. This mapping may be one-one, one-to-many in either direction. The adapter perform mapping/transformation of data between the Generic Model in the abstraction layer and the Application specific model in the application. This mapping may be performed in both directions. The adapter may further perform mapping/transformation of Operation & Management (O&M) data, or Operation & Maintenance data, between the abstraction layer and the application. This mapping may also be performed in both directions. In example embodiment, the adapter may further be configured to handle communication protocol related conversions/buffering/retransmissions, etc. according to OSI or whatever model the application supports.

FIG. 21 is an Illustration of a dashboard, “Process Monitor” in FIG. 21, where the state of the Abstraction Layer can be monitored. For instance, it is possible to view where requests are queued, errors, timeouts, delays and other performance statistics. In this way, it is possible to identify possible problems such as delays with the purpose of identifying suitable actions (e.g. increase some bandwidth, computer performance, etc.) and to check how each system is performing. This information can be correlated with the business processes defined in the Business Process Management Tool, thereby correlating the performance with each business process. In this way, it is possible to see what processes are affected by a certain problem. Or, the other way around, if there is an observed performance problem with a certain process, the tool can help identify in what adaptors/applications the problem seems to occur. It can also be used to derive business related information such as increased customer activity, churn, etc. that can accumulate activities from several applications. In addition, real time business information, such as current sales rate etc., may be presented.

FIG. 22 illustrates examples of Artificial Intelligence (AI) and O&M model interactions in the Abstraction Layer, e.g. a bus arrangement or computer system. The dashed lines 1, 2, 3, 4.1, 4.2, 4.3 and 4.4 in FIG. 22 illustrates these interactions in the Abstraction Layer and are referred to below. In FIG. 22, An AI module can be used to automate and tune desired functions and thresholds. It may contain the functions for categorizing, model training, process automation and machine reasoning.

1. In dashed line 1 in FIG. 22, the Artificial Intelligence (AI) module is consulted by the Rules. Built-in Machine Learning may be set to adjust rules for the purpose of optimizing certain values, such as sales or network performance. For example, learning which customers pay their bills and who do not and changing the rules accordingly. As a simple example, thresholds for accepting a customer as credit worthy when using external parties for scoring the credit worthiness can be adjusted. In other example embodiments, the credit worthiness of a customer is determined by a continuously trained neural network that monitors actual payment outcomes and thus learns from the ongoing business with all customers.

2. In dashed line 2 in FIG. 22, the AI module interact with the business processes to gather information or to initiate tasks. This may include gathering training information for e.g. its credit rating function as in the example (1), or it can be to automate the processes creation (“business process automation”). It can also combine smaller and simpler processes into more complex tasks using Machine reasoning or similar methods to achieve the desired tasks or solve challenges for which there are yet not any business processes defined.

3. In dashed line 3 in FIG. 22, the AI module is configured to control which application adapter should be used for different activity requests. In this way, the AI module may be used for configuring the Adapter socket in some cases. Connecting to the example above with credit worthiness determination, these cases may be which external party is used to determine the credit rating score in what case. The AI module may also be configured to send activity requests directly to the adapters to thereby initiate actions in the external systems, thus bypassing the process engine. This scenario may be relevant when the AI module is configured to have some built-in function that partially or completely replace the process engine, like the concept of “knowledge items”. In this example scenario, it may also be particularly beneficial to use the Adaptation Layer and related technology disclosed to thereby simplify the interaction, or integration, of AI with several external systems, in particular when there is a mix of automated and manually defined business processes.

4. In dashed line 4.1 to 4.4 in FIG. 22, the O&M model continuously maintains an image of the operational status of each external system (as reported by the adapters 4.4.), and of the internal functions such as the Business Process Engine (4.2), Rules engine (4.3) and the AI module (4.1). This means that each function (adapter socket or application adapter, business process, Rules engine, AI module) may consult the O&M model to determine actions. For example, if credit rating company 1 is “non-responsive”, “overloaded” or in “planned maintenance”, credit rating company 2 is used instead. If both Credit rating company 1 and Credit rating company 2 are non-responsive, the process can be defined to still allow purchases of less than a certain amount. Likewise, in the other direction, the application adapters may inform each external application of the operational status of the adapter (representing the abstraction layer) with the relevant contents in a suitable format for each external system if it needs to be aware of the operational status of the functions it expects the adapter to handle. The external application may instead of an ordinary application be an application adapter for another abstraction layer.

In embodiments, the technology disclosed defines a business process engine which hosts the execution of electronic business processes and generates event objects for communicating the state of business processes to a business rule engine. The business rule engine hosts the execution of business rule functions triggered dynamically in response to the event objects. Business rule functions exercise control over the business process engine or external systems, generate business metrics, react to business metrics and adjust parameters of business metrics and other rule functions. Business rule functions and business metrics may also generate event objects. A business management engine hosts the generation of business reports reflecting system status. Additionally, the business management engine receives user input manually creating, defining or re-defining business rule functions, metrics and business report format. B In embodiments, business rule functions, metrics and business report are created or defined during the real-time operation of the system without interrupting electronic business process flow within the business process engine.

In embodiments, a business rule engine hosts the execution of a plurality of business rule functions which are triggered dynamically in response to the event objects, separately or in correlation. Upon execution, business rule functions may exercise control over the business process engine or external systems (via appropriate system adapters), generate business metrics, react to business metrics and adjust parameters of business metrics and other rule functions.

Notably, business metrics themselves may be configured to dynamically generate event objects in response to attaining a predefined attribute or parameter value.

Modifications of the computer system arrangement according to the technology disclosed are of course possible within the scope of the claims. Furthermore, it is evident that the skilled person knows that a variety of different known components, both software and hardware and combinations thereof, may be used to achieve the functionality in accordance with the principles presented above. Moreover, it is foreseen that some of the functional aspects described above, as also some of the specific systems described above, may be the subject for their own patent applications, by means of filing of divisional applications.

A list of itemized embodiments of the present invention and technology disclosed is devised below:

1. A first embodiment defining a computer system (20) for minimizing communication and integration complexity between a plurality of external systems and/or software applications (3a-o), wherein each of said external systems and/or software applications (3a-o) has an individual data model (7a-o) each defining an individual set of application services and/or parameters (70a-o), said computer system (20) having connections (24a-o) to each one of said software applications or systems (3a-o), wherein said computer system (20) is arranged to interpret between each of said external systems and/or software applications (3a-o) and to orchestrate incoming requests from each of said external systems and/or software applications (3a-o), said computer system (20) is further comprising a plurality of adapters (23a-o), wherein at least one of said plurality of adapters (23a-o) is configured to
a. perform data transformation and/or mapping between at least one parameter of an individual data model of at least one of said external systems and/or software applications (3a-o) and at least one generic parameter and/or data of the computer system (20), and for
b. invoking at least one business process based on an incoming request received from one of said plurality of external systems and/or software applications (3a-o), wherein said at least one of said plurality of adapters (23a-o) is further configured to identify data and/or a service and/or a business process in one of said plurality of external system and/or software applications (3a-o) based on information in an outgoing request.

2. The computer system (20) according to the above first embodiment 1, wherein said outgoing request is an outgoing activity request which is initiated and generated from within said computer system (20).

3. The computer system (20) according to any of the above embodiments 1-2, wherein said at least one of said plurality of adapters (23a-o) is further configured to identify a service and/or a business process in one of said plurality of external system and/or a software applications (3a-o) based on at least one of data and address information in an outgoing activity request generated from a business process initiated and invoked from within the computer system (20).

4. The computer system (20) according to any of the above embodiments 1-3, wherein the computer system (20) is further configured so that the execution of the at least one business process based on said incoming request involves interaction with at least two other adapters (23a-o) among said plurality of adapters (23a-o) of the computer system (20).

5. The computer system (20) according to any of the above embodiments 1-4, wherein at least one of the plurality of adapters (23a-o) is configured to invoke a plurality of business processes based on a single incoming request from one of said external systems and/or software applications (3a-o).

6. The computer system (20) according to any of the above embodiments 1-5, wherein at least one of the plurality of adapters (23a-o) is configured to invoke a business process, which in turn is configured to invoke a rule function, and wherein the rule function is configured to be invoked from within the invoked business process.

7. The computer system (20) according to any of the above embodiments 1-6, wherein each of a plurality of adapters among said plurality of adapters (23a-o) is configured to invoke a plurality of at least one of sequentially and in parallel executed business processes in the computer system (20) based on a single incoming request received from one of said external systems and/or software applications (3a-o).

8. The computer system (20) according to any of the above embodiments 1-7, wherein each of the plurality of adapters (23a-o) is configured to invoke at least one business process in said computer system (20) based on a single incoming request received from one of said external systems and/or software applications (3a-o), wherein the at least one business process, when executed, is configured to invoke a rule function from within the at least one business process and the rule function is configured to be executed with the purpose of determining the further execution of at least one business process by selecting which process branch to be executed next among different business process options.

9. The computer system (20) according to any of the above embodiments 1-8, wherein a first adapter among the plurality of adapters (23a-o) is communicatively connected to a first external system and/or software application among said plurality of external systems and/or software applications (3a-o) and is configured to invoke a business process for initiating interaction with a plurality of other adapters (23a-o) among said plurality of adapters (23a-o), and wherein said plurality of other adapters (23a-o) are having connections to and configured for retrieving at least one of data and information from a second and a third external system and/or software application (3a-o) different from said first external system and/or software application based on said business process invoked by said first adapter following a single incoming request from said first external system and/or software application (3a-o) which is received by said first adapter (23a-o).

10. The computer system (20) according to any of the above embodiments 1-9, wherein said at least one business process is configured to invoke at least one additional business process to be executed within said computer system (20).

11. The computer system (20) according to any of the above embodiments 1-10, wherein each of said plurality of adapters (23a-o) is configured to perform mapping to a plurality of process IDs in said computer system (20) based on a single incoming request from one of said external systems and/or software applications (3a-o).

12. The computer system (20) according to any of the above embodiments 1-11, wherein a first adapter among said plurality of adapters (23a-o) comprises an adapter socket and a first application adapter, said first application adapter communicatively coupled to at least a first external system and/or software application, and a second adapter among said plurality of adapters (23a-o) comprises the same adapter socket and a second application adapter communicatively coupled to at least a second external system and/or software application, and wherein said adapter socket is a generic socket configured to both orchestrate incoming requests from both said first and said second external system and/or software application (3a-o) and to orchestrate outgoing activity requests from business processes executed within said computer system (20).

13. The computer system (20) according to embodiment 12, wherein said generic adapter socket is further configured to identify and/or perform mapping to a service and/or a business process of an external system and/or a software application based on data or address information in an outgoing activity request generated from a business process invoked from within the computer system (20).

14. The computer system (20) according to any of the above embodiments 12-13, wherein said generic adapter socket is further configured to identify and/or perform mapping to a service and/or a business process of an external system and/or a software application based on data or address information in an outgoing activity request generated from a business process invoked from within the computer system (20).

15. The computer system (20) according to any of the above embodiments 1-14, wherein at least one of the plurality of adapters (23a-o) is further configured to handle at least one of communication protocols (TCP/IP, FTP/IP, SSH, Web Services etc), communication link redundancy (fail over, load balancing etc), addressing translations (NAT etc), IP masquerading, encryptions (IP Sec) and/or operational status and alarm for the adapter itself (buffer overflow, timeouts) and/or a connected external system.

16. The computer system (20) according to any of the above embodiments 1-15, wherein at least one of the plurality of adapters (23a-o) is configured to invoke a single first business process in said computer system (20) which is executed by a process execution engine (22) of the computer system (20) and which is based on a single incoming request, and wherein said process execution engine (22) is further configured to execute at least one additional process which is invoked by said first business process based on said same single incoming request.

17. The computer system (20) according to any of the above embodiments 1-16, wherein said computer system (20) further comprises an adapter socket communicatively coupled to a plurality of application adapters (23a-o), an outgoing activity request generated by a business process which execution is initiated by and within said computer system (20),

18. The computer system (20) according to the above embodiment 17, wherein said adapter socket is configured to select, based on an identified service and/or address information in said activity request, one application adapter (23a-o), among said plurality of possible application adapters (23a-o), and wherein the selected one application adapter (23a-o) is having an Application Programming Interface (API) and is communicatively coupled to an external system and/or software application (3a-o) which is associated with data, an identified service and/or address information in said outgoing activity request.

19. The computer system (20) according to the above embodiment 18, wherein a plurality of said plurality of application adapter are configured to perform data transformation and/or mapping between at least one generic parameter among a set of generic parameters (61) defined by the generic information model (21) of said application adapter or the computer system (20) and a service and/or at least one parameter of an individual data model of one of the plurality of external systems and/or software applications (3a-o), and wherein said adapter socket is configured to, based on said same activity request, request/call at least one Application Programming Interface (API) and/or at least one business process to be executed by one of said external systems and/or software applications (3a-o).

20. The computer system (20) according to the above embodiment 19, wherein said application adapters are further configured to perform mapping of data and/or parameters and said adapter socket is configured to request/call at least one API and/or invoking said at least one business process based on the same single request received from said outgoing activity request which is generated by a business process initiated and executed within said computer system (20).

21. A method for minimizing communication and integration complexity between a plurality of external systems and/or software applications (3a-o), wherein each of said plurality of external systems and/or software applications (3a-o) has an individual data model (7a-o) each defining an individual set of data and/or application parameters (70a-o), and wherein each of said plurality of external systems and/or software applications (3a-o) is having connections to at least one adapter (23a-o) of an computer system (20), said computer system (20) is comprising a plurality of adapters (23a-o) arranged to interpret between each of the plurality of external systems and/or software applications (3a-o) and to orchestrate incoming and outgoing requests from each of the at least three software applications (3a-o) said method comprising:
a. receiving, at one of said plurality of adapters (23a-o), a request,
b. performing, by said one of said plurality of adapters (23a-o) and based on said request, data transformation and/or mapping between data and/or at least one parameter of an individual data model of one of the plurality of external systems and/or software applications (3a-o) and data and/or at least one generic parameter among a set of generic parameters (61) defined by the generic information model (21) of the information bus (20), and
c. invoking, by said one of said plurality of adapters (23a-o) and based on said same request, at least one business process,
   wherein said steps of performing mapping/transformation of data and/or parameters and invoking the at least one business process are based on the same single request received from one of the plurality of external systems and/or software applications (3a-o).

22. The method according to above embodiments 21, wherein the execution of the at least one business process involves interaction with at least two other adapters (23a-o) of the computer system (20).

23. The method according to any of above embodiments 21-22, further comprising invoking a plurality of business processes based on a single incoming or outgoing request received.

24. The method according to any of the above embodiments 21-23, wherein said at least one business process invokes a rule function, and wherein said rule function is invoked from within the invoked at least one business process.

25. The method according to any of the above embodiments 21-24, wherein said one of said at least three adapters (23a-o) invokes a plurality of at least one of sequentially and in parallel executed business processes in the computer system (20) based on said one of a single incoming request received from one of said at least three software applications (3a-o) and a single outgoing request from said computer system (20).

26. The method according to any of the above embodiments 21-25, wherein the at least one business process, when executed, invokes a rule function from within the at least one business process, and wherein the rule function is executed with the purpose of determining the further execution of business processes by selecting which process branch to be executed next among different business process options.

27. The method according to any of the above embodiments 21-26, further comprising invoking a business process to initiate interaction with a plurality of other adapters having connections to and configured for retrieving at least one of data and information from other applications based on a single incoming or outgoing request received by the adapter (23a-o).

28. The method according to any of the above embodiments 21-27, further comprising said one of said at least three adapters (23a-o) performs mapping between a process ID based on said single incoming or outgoing request.

29. The method according to any of the above embodiments 21-28, further comprising said one of said at least three adapters (23a-o) performs mapping between a plurality of process IDs based on said single incoming or outgoing request.

30. The method according to any of the above embodiments 21-29, further comprising said one of said at least three adapters (23a-o) performs mapping between a process ID and a rule function ID, or business rule ID, based on said single incoming or outgoing request.

31. A method for minimizing communication and integration complexity between a plurality of external systems and/or software applications (3a-o), wherein each of said plurality of external systems and/or software applications (3a-o) has an individual data model (7a-o) each defining an individual set of data and/or application parameters (70a-o), and wherein each of said plurality of external systems and/or software applications (3a-o) is having connections to at least one adapter (23a-o) of an computer system (20), said computer system (20) is comprising a plurality of adapters (23a-o) each arranged to interpret between at least one of the plurality of external systems and/or software applications (3a-o) and to orchestrate incoming and outgoing requests from at least one of said at least three software applications (3a-o) said method comprising:
a. receiving, by one of said plurality of adapters (23a-o), an outgoing activity request generated by a business process which execution is initiated by said computer system (20),
b. performing, by said one of said plurality of adapters (23a-o) and based on said request, data transformation and/or mapping between at least one generic parameter among a set of generic parameters (61) defined by the generic information model (21) of the computer system (20) and a service and/or at least one parameter of an individual data model of one of the plurality of external systems and/or software applications (3a-o), and
c. requesting and/or invoking, by said one of said plurality of adapters (23a-o) and based on said same activity request, at least one Application Programming Interface (API) and/or at least one business process to be executed by one of said external systems and/or software applications (3a-o),
   wherein said step of performing mapping of data and/or parameters and said step of requesting/calling at least one API and/or invoking the at least one business process are both based on the same single request received from said outgoing activity request which is generated by a business process initiated and executed within said computer system (20).

32. A method for minimizing communication and integration complexity between a plurality of external systems and/or software applications (3a-o), wherein each of said plurality of external systems and/or software applications (3a-o) has an individual data model (7a-o) each defining an individual set of data and/or application parameters (70a-o), and wherein each of said plurality of external systems and/or software applications (3a-o) is having connections to at least one application adapter (23a-o) of an computer system (20), said computer system (20) is comprising at least one adapter socket communicatively coupled to a plurality of adapters (23a-o) arranged to interpret between each of the plurality of external systems and/or software applications (3a-o) and to orchestrate incoming and outgoing requests from each of the at least three software applications (3a-o) said method comprising:
a. receiving, by an adapter socket communicatively coupled to a plurality of application adapters (23a-o), an outgoing activity request generated by a business process which execution is initiated by and within said computer system (20),
b. selecting, by said adapter socket and based on data, an identified service and/or address information in said activity request, one application adapter (23a-o), among said plurality of possible application adapters (23a-o), which in turn has an Application Programming Interface (API) and is communicatively coupled to an external system and/or software application (3a-o) which is associated with data, an identified service and/or address information in said outgoing activity request,
c. performing, by said selected one of said plurality of application adapters (23a-o) and based on said request, data transformation and/or mapping between at least one generic parameter among a set of generic parameters (61) defined by the generic information model (21) of said application adapter or the computer system (20) and a service and/or at least one parameter of an individual data model of one of the plurality of external systems and/or software applications (3a-o), and
d. requesting and/or invoking, by said one of said plurality of application adapters (23a-o) and based on said same activity request, at least one Application Programming Interface (API) and/or at least one business process to be executed by one of said external systems and/or software applications (3a-o),
wherein said step of performing mapping of data and/or parameters and said step of requesting/calling at least one API and/or invoking said at least one business process are both based on the same single request received from said outgoing activity request which is generated by a business process initiated and executed within said computer system (20).

33. A method for minimizing communication and integration complexity between a plurality of external systems and/or software applications (3a-o), wherein each of said plurality of external systems and/or software applications (3a-o) has an individual data model (7a-o) each defining an individual set of data and/or application parameters (70a-o), and wherein each of said plurality of external systems and/or software applications (3a-o) is having connections to at least one application adapter (23a-o) of an computer system (20), said computer system (20) is comprising at least one adapter socket communicatively coupled to a plurality of adapters (23a-o) arranged to interpret between each of the plurality of external systems and/or software applications (3a-o) and to orchestrate incoming and outgoing requests from each of the at least three software applications (3a-o), wherein each of the plurality of adapters (23a-o) is configured to invoke at least one business process in said computer system (20) based on a single incoming request received from one of said external systems and/or software applications (3a-o), and wherein the at least one business process, when executed, is configured to invoke a rule function from within the at least one business process and the rule function is configured to be executed with the purpose of determining the further execution of at least one business process by selecting which process branch to be executed next among different business process options is further, said method comprising:
a. consulting, by a rule, an Artificial Intelligence (AI) module, wherein built-in machine learning is used to adjust rules for the purpose of optimizing certain values,
b. interacting, by said AI module, with at least one business processes to gather information or to initiate tasks, and
c. controlling, by said AI module, which application adapter should be used for different activity requests,

34. The method according to any of the above embodiments 21-33, further comprising configuring, by an Artificial Intelligence (AI), an adapter socket.

35. The method according to any of the above embodiments 21-33, further comprising continuously monitoring and/or maintaining, by an O&M model, the operational status of at least one of the external systems and/or software applications and the internal functions of the computer system arrangement (20), where the internal functions include at least one of a Business Process Engine (4.2), a Rules engine (4.3) and/or an AI module (4.1).

36. The method according to embodiment 35, further comprising consulting, by at least one of the functions including an adapter socket or application adapter, a business process, a Rules engine an AI module, the O&M model to determine further actions.

37. The computer system (20) according to any of the above embodiments 1-20, further comprising an Artificial Intelligence (AI) adapted for configuring an adapter socket.

38. The computer system (20) according to any of the above embodiments 1-20, further comprising an O&M model configured for continuously monitoring and/or maintaining the operational status of at least one of the external systems and/or software applications and the internal functions of the computer system arrangement (20), where the internal functions include at least one of a Business Process Engine (4.2), a Rules engine (4.3) and/or an AI module (4.1).

39. The computer system (20) according to the above embodiment 38, wherein at least one of the functions (adapter socket or application adapter, business process, Rules engine, AI module) is configured to consult the O&M model to determine further actions.

1. A computer system for minimizing communication and integration complexity between a plurality of external systems and/or software applications, wherein each of said external systems and/or software applications has an individual data model each defining an individual set of application services and/or parameters, said computer system having connections to each one of said software applications or systems, wherein said computer system is arranged to interpret between each of said external systems and/or software applications and to orchestrate incoming requests from each of said external systems and/or software applications, said computer system is further comprising a plurality of adapters, wherein at least one of said plurality of adapters is configured to:
a. perform data transformation and/or mapping between at least one parameter of an individual data model of at least one of said external systems and/or software applications and at least one generic parameter and/or data of the computer system, and
b. invoking at least one business process based on an incoming request received from one of said plurality of external systems and/or software applications.

2. The computer system according claim 1, wherein said at least one of said plurality of adapters is further configured to identify data and/or a service and/or a business process in one of said plurality of external system and/or software applications based on information in an outgoing request which is initiated and generated from within said computer system.

3. The computer system according to claim 1, wherein the computer system is further configured so that the execution of the at least one business process based on an incoming request involves interaction with at least two other adapters among said plurality of adapters of the computer system.

4. The computer system according to claim 1, wherein at least one of the plurality of adapters is configured to invoke a plurality of business processes based on a single incoming request from one of said external systems and/or software applications, and wherein at least one business process of said computer system is configured to invoke at least one additional business process to be executed within said computer system.

5. The computer system according to claim 1, wherein at least one of the plurality of adapters is configured to invoke a business process, which in turn is configured to invoke a rule function, and wherein the rule function is configured to be invoked from within the invoked business process.

6. The computer system according to claim 1, wherein each of a plurality of adapters among said plurality of adapters is configured to invoke a plurality of at least one of sequentially and in parallel executed business processes in the computer system based on a single incoming request received from one of said external systems and/or software applications.

7. The computer system according to claim 1, wherein each of the plurality of adapters is configured to invoke at least one business process in said computer system based on a single incoming request received from me of said external systems and/or software applications, wherein the at least one business process, when executed, is configured to invoke a rule function from within the at least one business process and the rule function is configured to be executed with the purpose of determining the further execution of at least one business process by selecting which process branch to be executed next among different business process options,

8. The computer system according to claim 1, wherein a first adapter among said plurality of adapters comprises an adapter socket and a first application adapter, said first application adapter communicatively coupled to at least a first external system and/or software application, and a second application adapter communicatively coupled to the same adapter socket and communicatively coupled to at least a second external system and/or software application, and wherein said adapter socket is a generic socket configured to both orchestrate incoming requests from both said first and said second external system and/or software application and to orchestrate outgoing activity requests from business processes executed within said computer system.

9. The computer system according to claim 1, wherein at least one of the plurality of adapters is further configured to handle at least one of communication protocols, communication link redundancy, addressing translations, IP masquerading, encryptions and/or operational status and alarm for the adapter itself and/or a connected external system.

10. A method for minimizing communication and integration complexity between a plurality of external systems and/or software applications, wherein each of said plurality of external systems and/or software applications has an individual data model each defining an individual set of data and/or application parameters, and wherein each of said plurality of external systems and/or software applications is having connections to at least one adapter of an computer system, said computer system is comprising a plurality of adapters arranged to interpret between each of the plurality of external systems and/or software applications and to orchestrate incoming and outgoing requests from each of the at least three software applications said method comprising:
a. receiving, at one of said plurality of adapters, a request,
b. performing, by said one of said plurality of adapters and based on said request, data transformation and/or mapping between data and/or at least one parameter of an individual data model of one of the plurality of external systems and/or software applications and data and/or at least one generic parameter among a set of generic parameters defined by the generic information model of the information bus, and
c. invoking, by said one of said plurality of adapters and based on said same request, at least one business process,
wherein said steps of performing mapping/transformation of data and/or parameters and invoking the at least one business process are based on the same single request received from one of the plurality of external systems and/or software applications, said method further comprising
d. invoking a rule function from within one of the at least one invoked business process,
wherein said rule function is executed with the purpose of determining the further execution of at least one business process by selecting which process branch to be executed next among different business process options.
